(19) United States
(12) Patent Application Publication
(10) Pub. No.: US 2025/0330980 A1
(43) Pub. Date: Oct. 23, 2025

(54) INFORMATION INDICATION METHOD, REPEATER AND NETWORK DEVICE

(71) Applicant: FUJITSU LIMITED, Kawasaki-shi (JP)

(72) Inventors: Qinyan JIANG, Beijing (CN); Lei ZHANG, Beijing (CN); Yan TIAN, Beijing (CN)

(73) Assignee: FUJITSU LIMITED, Kawasaki-shi (JP)

(21) Appl. No.: 19/192,466

(22) Filed: Apr. 29, 2025

Related U.S. Application Data
(63) Continuation of application No. PCT/CN2022/130145, filed on Nov. 4, 2022.

(51) Int. Cl. H04W 72/20; H04L 27/26; H04W 16/28; H04W 72/044

(52) U.S. Cl. CPC H04W 72/20; H04L 27/26025; H04W 16/28; H04W 72/044

(57) ABSTRACT

A repeater includes: a mobile termination configured to communicate with a network device via a control link to receive control information; and, a forwarding entity, configured to perform amplifying-and-forwarding of uplink (UL) and/or downlink (DL) radio frequency (RF) signals between the network device and a terminal equipment via a backhaul link and an access link, a behavior of the forwarding entity being controlled according to the control information received by the mobile termination, wherein, states of the forwarding entity include ON state to transmit signals and OFF state to not transmit signals; wherein the control information includes a first information used for indicating a time domain resource and a second information used for indicating a beam for the access link by indicating a beam index of the beam.

### CROSS-REFERENCE TO RELATED APPLICATION

This application is a continuation application under 35 U.S.C. 111 (a) of International Patent Application PCT/CN2022/130145 filed on Nov. 4, 2022, and designated the U.S., the entire contents of which are incorporated herein by reference.

### TECHNICAL FIELD

This disclosure relates to the field of communication technologies.

### BACKGROUND

Compared with traditional 3G (third generation mobile communication technology) and 4G (fourth generation mobile communication technology) systems, a 5G (fifth generation mobile communication technology) system is able to provide larger bandwidths and higher data rates, and is able to support more types of terminals and vertical services.

For this reason, 5G systems are also deployed at new frequency bands, which are obviously higher than those of 3G and 4G systems. For example, a 5G system may be deployed in a millimeter waveband (such as 28 GHZ, 38GHz, 60 GHz, and higher wavebands).

According to the principle of propagation of wireless signals, the higher a carrier frequency, the more severe a fading experienced by signals during transmission. Therefore, in actual deployment, a 5G system needs a cell coverage enhancement method more than 3G and 4G systems need, especially a 5G system deployed in a millimeter waveband. Hence, how to better enhance cell coverage of a 5G system has become an urgent problem to be solved.

It should be noted that the above description of the background is merely provided for clear and complete explanation of this disclosure and for easy understanding by those skilled in the art. And it should not be understood that the above technical solution is known to those skilled in the art as it is described in the background of this disclosure.

### SUMMARY

In order to better solve the coverage problem of cellular mobile communication systems in practical deployment, use of a radio frequency (RF) relay/repeater to amplify and forward signals between a terminal equipment and a network device is commonly used means of deployment. RF repeaters are widely used in actual deployment of 3G and 4G systems. Generally speaking, an RF repeater is a device that amplifies and forwards signals between an amplification device and a forwarding device in the RF domain. That is, an RF repeater is a non-regenerative relay node, which only directly amplifies and forwards all received signals.

It was found by the inventors that a traditional RF repeater is unable to exchange information with other devices (e.g. network devices/terminal equipment, etc.). Specifically, in terms of reception, a traditional RF repeater does not support measurement/demodulation/decoding of forwarding signals, nor does it receive signals other than the forwarding signals. In terms of transmission, a traditional RF repeater only amplifies and forwards signals, and does not support generating signals and transmitting signals generated by themselves. Therefore, the forwarding behavior of a traditional RF repeater is not controlled by a network (e.g. via a network device, etc.). For example, ON/OFF states of the repeater is usually set manually.

It was realized by the inventors that ON/OFF of a traditional repeater is usually set manually, which is unable to dynamically match data transmission between a network device and a UE. In general, data transmission is not constantly performed between network devices and terminal equipment. If the repeater remains in an ON state even when there is no data transmission between a network device and a terminal equipment, unnecessary power consumption will be increased on one hand, and on the other hand, interference to other devices may be caused, thereby reducing network throughput. Therefore, compared to traditional repeaters, ON/OFF functions of repeaters are needed. However, there is currently no specific control method for ON/OFF states.

In order to solve at least one of the above problems, embodiments of this disclosure provide an information indication method, a repeater and a network device.

According to one aspect of the embodiments of this disclosure, there is provided a repeater, including:

a receiving unit configured to receive first control information at a mobile termination of the repeater, the first control information at least including first information for indicating a time domain resource,

a forwarding unit of the repeater being in a first state, or a second state, or a third state within the time domain resource indicated by the first information.

According to another aspect of the embodiments of this disclosure, there is provided a network device, including:

a transmitting unit configured to transmit first control information to a repeater, the first control information at least including first information for indicating a time domain resource, and/or transmit or not to transmit second control information, the second control information being used to indicate a forwarding unit to forward signals within a time domain resource.

According to a further aspect of the embodiments of this disclosure, there is provided a communication system, including a repeater as described in the one aspect and/or a network device as described in the other aspect.

An advantage of the embodiments of this disclosure exists in that ON/OFF of the repeater may be controlled by the first control information, ensuring that the time domain resources to which the ON state of repeater corresponds match with the time domain resources for data transmission between the network device and the terminal equipment. This not only conserves power consumption of the repeater, but also reduces interference to other devices in the network, thereby enhancing network throughput.

With reference to the following description and drawings, the particular embodiments of this disclosure are disclosed in detail, and the principle of this disclosure and the manners of use are indicated. It should be understood that the scope of the embodiments of this disclosure is not limited thereto. The embodiments of this disclosure contain many alternations, modifications and equivalents within the spirits and scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “comprise/comprising/include/including” when used in this specification is taken to specify the presence of stated features, integers, steps or components but does not preclude the presence or addition of one or more other features, integers, steps, components or groups thereof.

### BRIEF DESCRIPTION OF THE DRAWINGS

Elements and features depicted in one drawing or embodiments of the disclosure may be combined with elements and features depicted in one or more additional drawings or embodiments. Moreover, in the drawings, like reference numerals designate corresponding parts throughout the several views and may be used to designate like or similar parts in more than one embodiment.

The drawings are included to provide further understanding of this disclosure, which constitute a part of the specification and illustrate the preferred embodiments of this disclosure, and are used for setting forth the principles of this disclosure together with the description. It is obvious that the accompanying drawings in the following description are some embodiments of this disclosure, and for those of ordinary skills in the art, other accompanying drawings may be obtained according to these accompanying drawings without making an inventive effort. In the drawings:

FIG. 1 is schematic diagram of a communication system of embodiments of this disclosure;

FIG. 2 is a schematic diagram of an information indication method of embodiments of this disclosure;

FIG. 3 is a schematic diagram of states of the embodiments of this disclosure;

FIGS. 4A-4C schematic diagrams of access link beams of the embodiments of this disclosure;

FIG. 5 is a schematic diagram of a repeater of embodiments of this disclosure;

FIG. 6 is a schematic diagram of an information indication method of embodiments of this disclosure;

FIG. 7 is a schematic diagram of a network device of embodiments of this disclosure; and

FIG. 8 is a schematic diagram of an electronic device of embodiments of this disclosure.

### DETAILED DESCRIPTION OF THE DISCLOSURE

These and further aspects and features of this disclosure will be apparent with reference to the following description and attached drawings. In the description and drawings, particular embodiments of the disclosure have been disclosed in detail as being indicative of some of the ways in which the principles of the disclosure may be employed, but it is understood that the disclosure is not limited correspondingly in scope. Rather, the disclosure includes all changes, modifications and equivalents coming within the spirit and terms of the appended claims.

In the embodiments of this disclosure, terms “first”, and “second”, etc., are used to differentiate different elements with respect to names, and do not indicate spatial arrangement or temporal orders of these elements, and these elements should not be limited by these terms. Terms “and/or” include any one and all combinations of one or more relevantly listed terms. Terms “contain”, “include” and “have” refer to existence of stated features, elements, components, or assemblies, but do not exclude existence or addition of one or more other features, elements, components, or assemblies.

In the embodiments of this disclosure, single forms “a”, and “the”, etc., include plural forms, and should be understood as “a kind of” or “a type of” in a broad sense, but should not defined as a meaning of “one”; and the term “the” should be understood as including both a single form and a plural form, except specified otherwise. Furthermore, the term “according to” should be understood as “at least partially according to”, the term “based on” should be understood as “at least partially based on”, except specified otherwise.

In the embodiments of this disclosure, the term “communication network” or “wireless communication network” may refer to a network satisfying any one of the following communication standards: long term evolution (LTE), long term evolution-advanced (LTE-A), wideband code division multiple access (WCDMA), and high-speed packet access (HSPA), etc.

And communication between devices in a communication system may be performed according to communication protocols at any stage, which may, for example, include but not limited to the following communication protocols: 1G (generation), 2G, 2.5G, 2.75G, 3G, 4G, 4.5G, and 5G and new radio (NR) in the future, etc., and/or other communication protocols that are currently known or will be developed in the future. In the embodiments of this disclosure, the term “network device”, for example, refers to a device in a communication system that accesses a user equipment to the communication network and provides services for the user equipment. The network device may include but not limited to the following devices: a base station (BS), an access point (AP), a transmission reception point (TRP), a broadcast transmitter, a mobile management entity (MME), a gateway, a server, a radio network controller (RNC), a base station controller (BSC), etc.

The base station may include but not limited to a node B (NodeB or NB), an evolved node B (eNodeB or eNB), and a 5G base station (gNB), etc. Furthermore, it may include a remote radio head (RRH), a remote radio unit (RRU), a relay, or a low-power node (such as a femto, and a pico, etc.). The term “base station” may include some or all of its functions, and each base station may provide communication coverage for a specific geographical area. And a term “cell” may refer to a base station and/or its coverage area, depending on a context of the term.

In the embodiments of this disclosure, the term “user equipment (UE)” refers to, for example, an equipment accessing to a communication network and receiving network services via a network device, and may also be referred to as “a terminal equipment (TE)”. The terminal equipment may be fixed or mobile, and may also be referred to as a mobile station (MS), a terminal, a subscriber station (SS), an access terminal (AT), an IAB-MT, or a station, etc.

The terminal equipment may include but not limited to the following devices: a cellular phone, a personal digital assistant (PDA), a wireless modem, a wireless communication device, a hand-held device, an machine-type communication device, a lap-top, a cordless telephone, a smart cell phone, a smart watch, and a digital camera, etc.

For another example, in a scenario of the Internet of Things (IoT), etc., the user equipment may also be a machine or a device performing monitoring or measurement. For example, it may include but not limited to a machine-type communication (MTC) terminal, a vehicle mounted communication terminal, a device to device (D2D) terminal, and a machine to machine (M2M) terminal, etc.

In the embodiments of this disclosure, existing traffics or traffics that may be implemented in the future may be performed between a network device and a terminal equipment. For example, such traffics may include but not limited to enhanced mobile broadband (eMBB), massive machine type communication (mMTC), ultra-reliable and low-latency communication (URLLC), and vehicle to everything (V2X) communication, etc.

A traditional repeater does not have capability to communicate with a network device. Hence, although a traditional repeater is helpful to enhance signal strengths, it is not flexible enough to cope with complex environmental changes. Deploying a traditional repeater in a 5G network (especially a high-frequency 5G network) may possibly cause unnecessary interference to other network devices and/or terminal equipment, thereby reducing a transmission efficiency (such as throughput) of the entire network. In order that forwarding of the repeater is more flexible to be adapted to characteristics of the 5G network, the network device needs to assist the repeater, and configure forwarding of the repeater according to network conditions.

A network controlled repeater (NCR) scheme is proposed in 3GPP Rel-18 to enhance NR coverage, so as to forward signals between a network device and a terminal equipment. NCR may directly communicate with the network device via control links to assist in forwarding operations of the NCR.

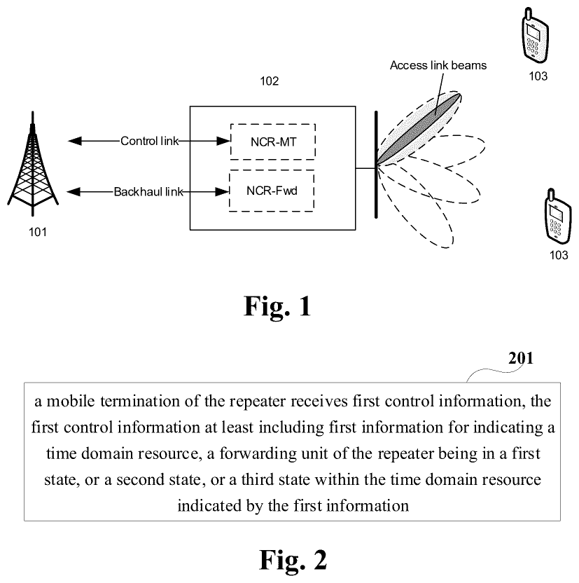

FIG. 1 is a schematic diagram of the NCR in embodiments of this disclosure. As shown in FIG. 1, NCR 102 is configured between a network device 101 and a terminal equipment 103. NCR 102 may include the following two modules/components: a mobile termination of the repeater (NCR-MT) and a forwarding unit of the repeater (NCR-Fwd). The NCR-Fwd may also be referred to as a routing unit of the NCR (NCR-RU). The NCR-MT is used for communication with the network device (information exchange), the NCR-Fwd is used for forwarding signals between the network device and the terminal equipment, and the NCR-MT and NCR-Fwd are functional entities, with functions thereof being implemented by identical or different hardware modules.

As shown in FIG. 1, the NCR of the embodiments of this disclosure may have three links: a control link (C-link), a backhaul link (BH link) and an access link (AC link) for forwarding, wherein the C-link is used for communication between the NCR and the network device, the BH link is used by the repeater to receive signals to be forwarded from the network device, or forward signals from the terminal equipment to the network device, and the AC link is used by the repeater to forward signals from the network device to the terminal equipment, or receive signals to be forwarded from the terminal equipment. Specifically, the NCR-MT communicates with the network device via the C-link, and the NCR-Fwd forwards signals via the BH link and the AC link.

In the embodiments of this disclosure, the repeater may communicate with the network device, receive communication channels/signals transmitted by the network device, and demodulate/decode the channels/signals to obtain information transmitted by the network device to the repeater. A signal processing process is hereinafter referred to as “communication”. The repeater may also forward channels/signals transmitted between the network device and the terminal equipment, does not demodulate/decode the channels/signals, and may perform amplification, etc. A signal processing process is hereinafter referred to as “forwarding”, and “communication” and “forwarding” are collectively referred to as “transfer”. In addition, ‘performing transmission or reception on the AC link (or the BH)’ may be equivalent to ‘performing forwarding on the AC link (or the BH)’, and ‘performing transmission or reception on the control link’ may be equivalent to ‘performing communication on the control link’. The above terms are for convenience of explanation only, and are not intended to limit this disclosure. In some cases, “a forwarding unit” and “a forwarding behavior” are interchangeable.

In the embodiments of this disclosure, the repeater may also be expressed as a network-controlled repeater (NCR), a repeater, a radio frequency repeater, a relay, a radio frequency relay; or, it may also be expressed as a repeater node, or a relay node; or, it may also be expressed as an intelligent repeater, an intelligent relay, an intelligent repeater node, an intelligent relay node, etc.; however, this disclosure is not limited thereto.

In the embodiments of this disclosure, the network device may be a device of a serving cell of the terminal equipment, or a device in a cell where the repeater is located, or a device of a serving cell of the repeater, or a parent node of the repeater. Names of the repeater are not limited in this disclosure, and any device able to achieve the above functions is included in the scope of the repeater of this disclosure.

Implementations of the embodiments of this disclosure shall be described below with reference to the accompanying drawings. These implementations are illustrative only, and are not intended to limit this disclosure.

### Embodiments of a First Aspect

The embodiments of this disclosure provide an information indication method, which shall be described from a side of a repeater.

FIG. 2 is a schematic diagram of the information indication method of the embodiments of this disclosure. As shown in FIG. s, the method includes:

201: a mobile termination of the repeater receives first control information, the first control information at least including first information for indicating a time domain resource,

a forwarding unit of the repeater being in a first state, or a second state, or a third state within the time domain resource indicated by the first information.

It should be noted that FIG. 2 only schematically illustrates the embodiments of this disclosure; however, this disclosure is not limited thereto. For example, an order of execution of the steps may be appropriately adjusted, and furthermore, some other steps may be added, or some steps therein may be reduced. And appropriate variants may be made by those skilled in the art according to the above contents, without being limited to what is contained in FIG. 2.

In some embodiments, the first state may also be referred to as an ON state or a first ON state, the second state may also be referred to as a standby state or a switching state or a second ON state or a second OFF state, and the third state may also be referred to as an OFF state or a shutdown state or a first OFF state.

In some embodiments, the first state, the second state and the third state refer to states of the forwarding unit (NCR-Fwd) of the repeater. As described above, the NCR-Fwd is used to forward signals between the network device and the terminal equipment. The first state or the second state or the third state is used to denote an operating state or ON/OFF state of the NCR-Fwd.

In some embodiments, the first state denotes that the NCR-Fwd is forwarding signals. For example, that the forwarding unit is in the first state during a time period (or time domain resource) A refers to that the forwarding unit forwards signals during the time period, including forwarding downlink signals transmitted by the network device to the terminal equipment and/or forwarding uplink signals transmitted by the terminal equipment to the network device. It should be pointed out that if the forwarding unit forwards downlink signals and uplink signals in a time-division manner and/or forwards signals by using different BH link beams and/or AC link beams in a time-division manner in the time period, the time period includes a time during the forwarding unit performs uplink and downlink conversion and/or beam switching.

In some embodiments, the second state denotes that the NCR-Fwd is allowed or is able or is ready to forward signals. For example, when the forwarding unit is in the second state during a time period (or time domain resource) B, the forwarding unit is in a standby state in the time period, or the forwarding unit stops forwarding signals in the time period, or the forwarding unit does not forward signals in the time period, or the forwarding unit has capability to (or is allowed to, or is able to, or is capable of, or is ready to) forward signals in the time period.

In some embodiments, the third state denotes that the NCR-Fwd is not allowed or has no capability or is not ready to forward signals. For example, when the forwarding unit is in the third state during a time period (or time domain resource) C, the forwarding unit is in a shutdown state in the time period, or the forwarding unit stops forwarding signals in the time period, or the forwarding unit does not forward signals in the time period, or the forwarding unit has capability (or is allowed to, or is able to, or is capable of, or is ready to) forward signals in the time period, or the forwarding unit has no capability (is not allowed to, or is not able to, or is not capable of, or is not ready to) to forward signals in the time period.

In some embodiments, the NCR supports the first state, wherein output power requirements may also be defined for the first state. For example, output power of the NCR in the first state is not less than or is greater than first power (or power level), and/or output power of the NCR in the first state is not greater than or less than fourth power (or power level).

In some embodiments, the NCR (or the NCR-Fwd) only supports one of the second state and the third state. For example, the NCR supports the first state and the second state, or the first state and the third state.

In some embodiments, the NCR (or the NCR-Fwd) supports the second state and the third state. For example, the NCR supports the first state, the second state and the third state.

In some embodiments, the NCR (or the NCR-MT) may report whether it supports the second and/or the third state to the network device.

In some embodiments, output power requirements are defined only for the second state or only for the third state. For example, the output power of the NCR in the second state or third state is not greater than or less than second power (or power level) as below.

In some embodiments, output power requirements are defined for both the second state and the third state.

In some embodiments, the output power requirements for the second state and the third state are identical. For example, the output power of the NCR in the second state and the third state is not greater than or less than the second power (or power level) as below.

In some embodiments, the output power requirements for the NCR-Fwd in the second state and the third state are different. For example, if the NCR-Fwd is in the second state, the output power of the NCR-Fwd is not greater than or less than the second power, and if the NCR-Fwd is in the third state, the output power of the NCR-Fwd is not greater than or less than the third power. Values of the second power and the third power are different. For example, the second power is greater than the third power.

In some embodiments, the second power/the third power refer(s) to a power spectral density (dBm/MHz), which may be referred to as a second power spectral density and a third power spectral density, respectively. For example, the second power is equal to −85 dBm/MHz, and the third power is less than −85 dBm/MHz, or the second power is greater than −85 dBm/MHz, and the third power is equal to −85 dBm/MHz. For another example, the second power is equal to −50 dBm/(SCS×(12×N_{RB}+1)/1000) MHz, and the third power is less than −50 dBm/(SCS×(12×N_{RB}+1)/1000) MHz; or, the second power is greater than −50 dBm/(SCS×(12×N_{RB}+1)/1000) MHz, and the third power is equal to −50 dBm/(SCS×(12×N_{RB}+1)/1000) MHz. The SCS (subcarrier spacing) is, for example, an SCS of a forwarding signal (not being forwarded); however, it is not limited thereto. For a further example, the second power is equal to −36 dBm/MHz, and the third power is less than −36 dBm/MHz, or the second power is greater than −36 dBm/MHz, and the third power is equal to −36 dBm/MHz.

In some embodiments, the output power requirements for the NCR-Fwd may be defined separately for uplink and downlink, that is, the above second power and/or the third power may be defined separately for output power of the BH link and AC link. For example, for the output power of the downlink or the AC link, the second power is equal to −85 dBm/MHz, and the third power is less than −85 dBm/MHz, or the second power is greater than −85 dBm/MHz, and the third power is equal to −85 dBm/MHz. For the output power of the uplink or the BH link, the second power is equal to −50 dBm/(SCS×(12×N_{RB}+1)/1000) MHz, and the third power is less than −50 dBm/(SCS×(12×N_{RB}+1)/1000) MHz; or, the second power is greater than −50 dBm/(SCS×(12×N_{RB}+1)/1000) MHz, and the third power is equal to −50 dBm/(SCS×(12×N_{RB}+1)/1000) MHz. The subcarrier spacing SCS is, for example, an SCS of a forwarding signal (not being forwarded); however, it is not limited thereto.

In some embodiments, output power requirements may be defined for different operating frequency bands or frequency ranges (e.g. FR1, FR2, FR2-1, FR2-2), that is, the above second power and/or the third power may be defined for output power of the NCR-Fwd operating at different frequency bands or frequency ranges. For example, for the output power of the downlink or the AC link of FR1, the second power is equal to −85 dBm/MHz, and the third power is less than −85 dBm/MHz, or, the second power is greater than −85 dBm/MHz, and the third power is equal to −85 dBm/MHz, and for the output power of the uplink or the BH link of FR1, the second power is equal to−50 dBm/(SCS×(12×N_{RB}+1)/1000) MHz, and the third power is less than −50 dBm/(SCS×(12×N_{RB}+1)/1000) MHz, or, the second power is greater than −50 dBm/(SCS*(12*N_{RB}+1)/1000) MHz, and the third power is equal to −50 dBm/(SCS×(12×N_{RB}+1)/1000) MHz. The subcarrier spacing SCS is, for example, an SCS of a forwarding signal (not being forwarded); however, it is not limited thereto. For another example, for output power of FR2, the second power is equal to −36 dBm/MHz, and the third power is less than −36 dBm/MHz, or, the second power is greater than −36 dBm/MHz, and the third power is equal to −36 dBm/MHz.

In some embodiments, the output power of the NCR-Fwd in the second state or the third state is respectively defined as average power measured over/greater than/not less than a length of time in a period of time when it is in the second state or the third state, such as average power measured over/greater than/not less than a length of time in the period of time when it is in the second state or the third state and filtered by a filter (e.g. a square filter) centered on an assigned channel frequency with a bandwidth equal to a passband bandwidth of the NCR-Fwd, wherein the length of time is related to an SCS, for example, the length of time=70/Nus, N=SCS/15. The SCS is, for example, an SCS of a forwarding signal (not being forwarded); however, it is not limited thereto. In some embodiments, directly transition (or switch) of the forwarding unit from the third state to the first state is supported, or, directly transition of the forwarding unit from the third state to the first state and/or directly transition of the forwarding unit from the first state to the third state is/are not supported, that is, if the NCR-Fwd is in the third state, it must first transition to the second state, and then transition from the second state to the first state. Likewise, direct transition of the forwarding unit from the first state to the third state is supported or not supported.

In some embodiments, only a transient period (or switching time) between the first state and the second state or only a transient period between the first state and the third state is defined, such as a first transient period as below. That is, the first transient period is included only in switching of the first state and the second state, and is not included in switching of the first state and the third state, or, the first transient period is included only in switching of the first state and the third state, and is not included in switching of the first state and the second state.

In some embodiments, the transient period between the first state and the second state and the transient period between the first state and the third state are defined, that is, the transient period is included in switching of the first state and the second state, and the transient period is also included in switching of the first state and the third state. Additionally, a transient period between the second state and the third state may be defined or not defined.

In some embodiments, a length of the transient period between the first state and the second state is identical to that of the transient period between the first state and the third state, such as the first transient period.

In some embodiments, the length of the transient period between the first state and the second state is different from a length of the transient period between the first state and the third state. For example, the transient period between the first state and the second state is the first transient period, the transient period between the first state and the third state is a second transient period, and the first transient period is less than the second transient period. For example, the first transient period is equal to 10 us, and the second transient period is greater than 10 us, or, the first transient period is less than 10 us, and the second transient period is equal to 10 us. For another example, the first transient period is equal to 3 us, and the second transient period is greater than 3 us, or, the first transient period is less than 3 us, and the second transient period is equal to 3 us.

In some embodiments, transient periods may be defined separately for different operating frequency bands or frequency ranges (e.g. FR1, FR2, FR2-1, FR2-2), that is, for the NCR-Fwd operating in different frequency bands or frequency ranges, the first transient period and/or the second transient period may be defined separately. For example, for FR1, the first transient period is equal to 10 us, and the second transient period is greater than 10 us, or, the first transient period is less than 10 us, and the second transient period is equal to 10 us, and for FR2, the first transient period is equal to 3 us, and the second transient period is greater than 3 us, or, the first transient period is less than 3 us, and the second transient period is equal to 3 us.

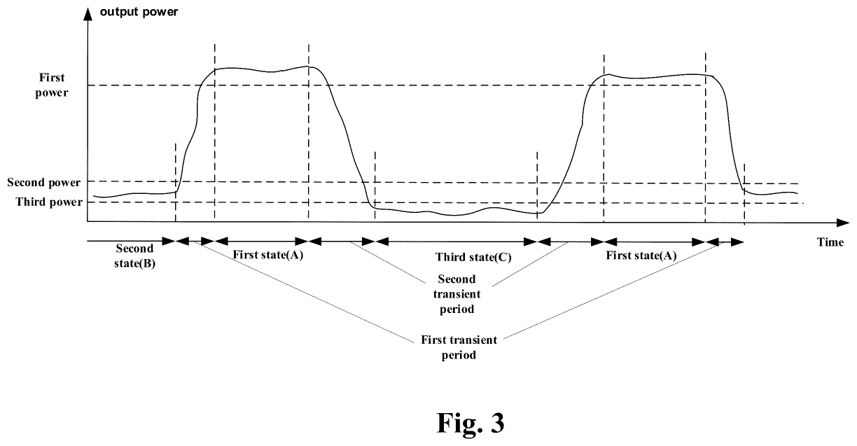

FIG. 3 is a schematic diagram of the transient periods and output power in the states in the embodiments of this disclosure (assuming that requirements for the transient periods and output power are all different). As shown in FIG. 3, switching from the second state to the first state includes the first transient period, switching from the first state to the third state includes the second transient period, output power of the NCR-Fwd in the first state is greater than first power, output power of the NCR-Fwd in the second state is less than second power, and output power of the NCR-Fwd in the third state is less than third power. The first power>the second power>the third power, and values thereof are different. FIG. 3 is illustrative only, for example, the second power and the third power may be identical, and the first transient period and second transient period may be identical, or, state transition may not include the first transient period and the second transient period, which shall not be enumerated herein any further.

Behaviors of the forwarding unit in different states are described above, and behaviors of the mobile termination when the forwarding unit is in different states shall be described below.

In some embodiments, the forwarding unit is in the third state within the time period D, and the mobile termination (NCR-MT) does not receive a part or all of downlink signals and/or does not transmit a part or all of uplink signals within the time period D. For example, the downlink signals include second control information indicating the forwarding unit to forward signals, the second control information including RRC or an MAC CE or DCI.

In some embodiments, the forwarding unit is in the third state within the time period D, and within the time period D, the mobile termination does not monitor a DCI format used to indicate the forwarding unit to forward signals, or within the time period, the mobile termination does not expect to receive the second control information (such as the DCI) indicating the forwarding unit to forward signals, or the mobile termination does not expect to receive the second control information (such as the RRC or MAC CE or DCI) indicating the forwarding unit to forward signals within the time period.

Or, the forwarding unit is in the second state or third state within the time period D, and the mobile termination monitors, within the time period, a DCI format used to indicate the forwarding unit to forward signals, or within the time period, the mobile termination receives the second control information indicating the forwarding unit to forward signals within the time period, or, after receiving the first control information, the mobile termination receives the second control information indicating the forwarding unit to forward signals within the time period.

In some embodiments, the first state, the second state and third state refer to states of the mobile termination (NCR-MT) of the repeater, and the first state or the second state or the third state is used to denote an operating state or ON/OFF states of the NCR-MT.

In some embodiments, the third state denotes that the NCR-MT does not transmit or receive signals on the C-link. For example, in the third state, the mobile termination (NCR-MT) does not receive a part or all of downlink signals, and/or does not transmit a part or all of uplink signals, within the time period D. For example, the downlink signals include the second control information used to indicate that the forwarding unit forwards signals, the second control information including RRC or an MAC CE or DCI.

In some embodiments, the third state denotes that the NCR-MT does not monitor signals transmitted or received on the C-link or does not expect to transmit or receive signals on the C-link. For example, in the third state, within the time period D, the mobile termination does not monitor the DCI format used to indicate that the forwarding unit forwards signals, or the mobile termination does not expect to receive the second control information (such as DCI) within the time period used to indicate that the forwarding unit forwards signals, or the mobile termination does not expect to receive the second control information (such as RRC or an MAC CE or DCI) used to indicate that the forwarding unit forwards signals within the time period.

Or, the second state or third state denotes that the NCR-MT monitors signals transmitted or received on the C-link or transmits or receives signals on the C-link. For example, in the second state or the third state, the mobile termination monitors, within the time period, the DCI format used to indicate that the forwarding unit forwards signals, or the mobile termination receives the second control information used to indicate that the forwarding unit forwards signals within the time period, or the mobile termination receives the second control information used to indicate that the forwarding unit forwards signals within the time period after receiving the first control information.

In some embodiments, the time period to which the first state or the second state or the third state corresponds is represented by a time domain resource configured by the network device, that is, the mobile termination of the repeater receives the first control information transmitted by the network device, the first control information including DCI and/or RRC signaling and/or an MAC CE. The first control information at least includes first information used to indicate a time domain resource (time period). The first information may explicitly or implicitly indicate that the forwarding unit is in the first state or the second state or the third state in the time domain resource, hence, the forwarding unit of the repeater is in the first state or the second state or the third state in the time domain resource indicated by the first information.

How the first information indicates the time domain resource shall be described below.

In some embodiments, the first information may be carried by one or more first information fields, the one or more first information fields indicating a starting position (offset) and/or a duration and/or a spacing and/or a period of the time domain resource. The time domain resource is periodic or semi-persistent or aperiodic. The starting position (offset) and/or the duration and/or the spacing and/or the period may be indicated at a granularity of a time unit, such as a subframe, a slot, a symbol, a mini-slot, and a millisecond, etc.

In some embodiments, the first information field may include the number of time units included in the starting position (offset) and/or the duration and/or the spacing and/or the period of the time domain resource (such as field_1 and/or field_2 in Element_2 in a subsequent example), the number of time units indicating the starting position (offset) and/or the duration and/or the spacing and/or the period of the time domain resource, or the first information field may include an index of an time unit (such as field_3 in Element_2 in the subsequent example), or the first information field (such as a time domain resource allocation information field described later) may further include a row index value, and the starting position (offset) and/or the duration and/or the spacing and/or the period is/are indicated by the index value and a time domain resource allocation table.

In some embodiments, when the first information is carried by multiple (X) first information fields, information related to time domain resources indicated by different first information fields is different. For example, different first information fields may respectively indicate different information, such as an offset, a duration, and a period, etc. (such as field_1, field_2 and field_3 in Element_2 in the subsequent example), or, time units indicate by different first information fields are different, for example, different first information fields respectively indicate slots, and symbols, etc.; or, time domain resources indicated by different first information fields do not overlap or do not completely overlap; however, the embodiments of this disclosure are not limited thereto.

In some embodiments, when the first information is carried by multiple (X) first information fields, the X first information fields may be divided into multiple (Y) groups of first information fields, each group of first information fields including one or more (Z) first information fields. One group of first information fields indicates a part of resources of time domain resources, and time domain resources indicated by different groups of information fields do not overlap or do not completely overlap. For example, in example 6 described below, Element_2 includes a group of first information fields, in which three first information fields, field_1, field_2, and field_3, are included.

In some embodiments, the first control information may or may not include second information used to indicate one or more access link beams, wherein whether the first control information includes second information is related to an operating frequency band (or frequency range) of the forwarding unit and/or capability and/or higher layer parameter configuration.

For example, when it is related to an operating frequency band (or frequency range), when the operating frequency band of the forwarding unit is at FR1, the first control information does not include the second information, and when the operating frequency band of the forwarding unit is at FR2, the first control information includes the second information;

For example, when it is related to capability, when the access link beam of the repeater is fixed (or only one access link beam (analog beam) is supported), the first control information includes the second information, and when the access link beam of the repeater may be adjusted or converted (or, in other words, the repeater supports more than one access link beam), the first control information includes the second information. In this example, the repeater may transmit or may not transmit the information related to capability to the network device. The information related to capability includes, for example, the number of access link beams supported by the repeater, and/or beam indices, and/or information related to spatial characteristics. The beam indices shall be described later.

For example, the operating frequency band of the repeater is at FR1, a default access link beam is fixed (or only one access link beam (analog beam) is supported), the repeater does not need to transmit the information related to capability to the network device; or, if the access link beam of the repeater may be adjusted/converted (or if the repeater supports more than one access link beams), the repeater transmits the information related to capability to the network device; otherwise, it does not need to transmit the information related to capability to the network device.

For example, the operating frequency band of the repeater is at FR2, the default access link beam may be adjusted/converted (or, in other words, the repeater supports more than one access link beam), and the repeater does not need to transmit the information related to capability to the network device; or, if the access link beam of the repeater is fixed (or only one access link beam (analog beam) is supported), it transmits the information related to capability to the network device; otherwise, it does not need to transmit the information related to capability to a base station. For another example, the operating frequency band of the repeater is at FR1 or FR2, regardless of whether the access link beam is fixed or may be adjusted/converted (or, in other words, the repeater supports more than one access link beam), the repeater transmits the information related to capability to the network device. For example, when the access link beam is fixed, the number of reported access link beams is 1, or when the access link beam may be adjusted/converted (or, in other words, the repeater supports more than one (N) access link beam), the number of reported access link beams is N.

For example, it is related to higher layer parameter configuration (before the first control information in time), for example, assuming that the first control information is DCI (DCI format X_Y), this higher layer parameter being an information field of RRC signaling, the information field being (directly or indirectly) used to configure whether DCI format X_Y includes the second information. For example, the higher layer parameter may be of 1 bit, when the higher layer parameter configuration includes the second information (with a bit value of, for example, 1), DCI format X_Y includes the second information, and when the higher layer parameter configuration does not include the second information (with a bit value of, for example, 0), DCI format X_Y does not include the second information. For another example, in a case where an information element (IE) or another information field includes the information field, DCI format X_Y includes the second information; otherwise, it does not include the second information. For a further example, the higher layer parameter is used to configure beams that may be indicated by access link beams that DCI format X_Y is able to indicate (such as being referred to as candidate beams), one of the access link beams configured with a repeater is a candidate beam, and DCI format X_Y does not include the second information. More than one access link beam are configured as candidate beams, and DCI format X_Y includes the second information.

For example, higher layer parameters exampleField_4 and exampleField_5 may be expressed as follows by using an ASN. 1 data format:

exampleField_4 FFS (e.g. INTEGER (0..3) or Element_3) ,
OPTIONAL, Cond XYZ1
...
exampleField_5 ::= FFS (e. g. Element_4) ,
...

wherein, exampleField_4 is used to configure an information field in DCI format X_Y used for indicating an access link beam, INTEGER (0 . . . 3) may be the number of bits in the information field, and optionally, Element_3 may also be included, which is used to configure a list of beam patterns to which the information field corresponds (assuming that the information field indicates an index of a beam pattern). Regarding exampleField_4, it may be present or may not be present, that is, exampleField_4 is conditionally present. The condition XYZ1 includes: optional present for FR2 (or FR2-1), and absent for FR1; or, mandatory present for FR2 (or FR2-1), and absent for FR1; or, mandatory present for FR2 (or FR2-1); optional present for FR1.

Wherein, exampleField_5 is used to configure an information field in DCI format X_Y used to indicate a time domain resource, and Element_4 configures a list of time domain resources to which the information field corresponds, such as PDSCH-TimeDomainResourceAllocationList.

For example, higher layer parameters ExampleIE_6 or exampleField_6 may be expressed as follows by using an ASN.1 data format:

```
ExampleIE_6/exampleField_6 ::= SEQUENCE {
    aField FFS (e. g. INTEGER (0..3) or Element_3) ,
    OPTIONAL, Cond XYZ1
    anotherField FFS (e. g. Element_4) ,
    ...
```

wherein, ExampleIE_6 or exampleField_6 is used to configure DCI format X_Y, aField is used to configure an information field in DCI format X_Y used to indicate an access link beam, INTEGER (0 . . . 3) may be the number of bits in the information field; and optionally, Element_3 may also be included, which is used to configure a list of beam patterns to which the information field corresponds (assuming that the information field indicates an index of a beam pattern); however, the embodiments of this disclosure are not limited thereto. Regarding aField, it may be present or not present, that is, aField is conditionally present, and the condition XYZ1 is as described above, which shall not be repeated herein any further. anotherField is used to configure an information field in DCI format X_Y used to indicate a time domain resource, and Element_4 configure a list of time domain resources to which the information field corresponds, such as PDSCH-TimeDomainResourceAllocationList.

For example, the second information may be relevant information of one or more access link beams, the relevant information including a beam type and/or a beam index, etc., which shall be described later.

In some embodiments, the first control information further includes or does not include third information indicating the first state or the second state or the third state. For example, the third information may be 1-bit information or 2-bit information, and the 1-bit information or 2-bit information is used to indicate whether the forwarding unit is in the first state or the second state or the third state. For example, a bit value 0 indicates the first state, and a bit value 1 indicates the third state, which shall not be enumerated herein any further.

In some embodiments, the first control information is DCI (DCI format X_Y), and corresponding second information and third information include the same information field. That is, the same information field in DCI format X_Y provides the second information or the third information in different cases. For example, for FR1, the information field is used to provide the third information, and for FR2, the information field is used to provide the second information. For another example, in a case where the NCR supports or is configured with only one access link beam, the information field is used to provide the third information, and in a case where the NCR supports or is configured with more than one access link beam, the information field is used to provide the second information.

The following example illustrates implementation of the first control information.

In some embodiments, the first information explicitly indicates that the forwarding unit is in the first state or the second state or the third state in the time domain resource, that is, the first information is only used to indicate that the forwarding unit is in the first state or the second state or the third state in the time domain resource, and does not indicate any other content.

In the embodiments, the first control information includes or does not include the second information used to indicate one or more access link beams. For example, when the operating frequency band of the repeater is at FR1 and/or it does not support beam control or indication and/or the access link beam may be default or may be fixed or default (only one analog beam is supported), the network device will not transmit the second information used to indicate one or more access link beams to the terminal equipment, or, in other words, it will not transmit the second information used to indicate one or more access link beams in the first control information.

In the above embodiments, that the second information indicates one or more access link beams is taken as an example. However, the embodiments are not limited thereto, and the second information may further indicate one or more backhaul link beams, and implementations thereof are similar, which shall not be enumerated in the embodiments of this disclosure.

In the embodiments, the first control information may further include third information used to indicate the first state or the second state or the third state.

For example, the first control information includes the first information and does not include the second information, and optionally, it may further include the third information, in which case the access link beam may be default or may be fixed or default. The first information only indicates that the forwarding unit is in the first state or the second state or the third state in the time domain resource.

In some embodiments, the first information implicitly indicates that the forwarding unit is in the first state or the second state or the third state in the time domain resource. The first information is further used to indicate time domain resources to which one or more access link beams correspond and/or time domain resources to which one or more backhaul link beams correspond. The one or more access link beams and/or the one or more backhaul link beams are indicated by the second information included in the second control information. For example, the operating frequency band of the repeater is at FR2 and/or beam adjustment or indication or conversion is supported (or, in other words, the repeater supports more than one (N) access link beam), and the network device transmits the second information used to indicate one or more access link beams to the terminal equipment.

For example, the first control information includes the first information and the second information. The second information indicates one or more access link beams and/or one or more backhaul link beams, the first information indicates time domain resources to which one or more access link beams and/or one or more backhaul link beams correspond, and at the time, the first information may further implicitly indicate that the forwarding unit is in the first state or the second state or the third state in the time domain resources.

Following description shall be given by way of examples.

How to define the index of the access (AC) link beam shall be described first.

The AC link beam may also be known as a terminal equipment side beam, and refers to a receiving beam/transmitting beam adopted (used) by the repeater in the AC link. The transmitting beam forwards signals from the network device to the terminal equipment, and the receiving beam forwards signals from the terminal equipment to the network device. The backhaul link beam may also be known as a network device side beam, and refers to a receiving beam/transmitting beam adopted (used) by the repeater in the BH link. The receiving beam forwards signals from the terminal equipment to the network device, and the transmitting beam forwards signals from the network device to the terminal equipment. Wherein, a beam (of an antenna) refers to, for example, a main lobe of a radiation pattern of an antenna array.

In some embodiments, the repeater may support multiple beams (or antenna beams) in different directions and/or with different widths, and there may possibly exist correlations between the beams. For example, that there exists a correlation between a first beam and a second beam includes that: beam center directions of the first beam and the second beam are identical, and/or beam peak directions of the first beam and the second beam are identical, and/or the first beam and the second beam are quasi-colocated (such as QCL type D), and/or the first beam is within a range of the second beam, or the second beam is within a range of the first beam, and/or a beam width of the first beam is within a range of a beam width of the second beam, and/or the beam width of the second beam is within the range of the beam width of the first beam. Wherein, the beam center direction refers to, for example, a geometric center of a half power contour of the beam, and the beam peak direction refers to, for example, a direction of maximum EIRP of the beam.

Example 1: the beams supported by the NCR are numbered sequentially, and the numbering may be performed according to spatial relationships. For example, beams with adjacent numbers are spatially adjacent. For example, the NCR supports 4 beams, which are numbered from 0 or 1, and respective indices thereof are 0-3 or 1-4.

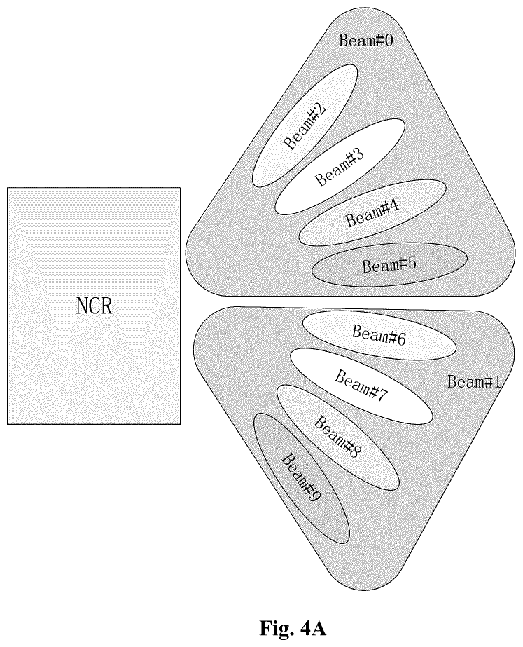

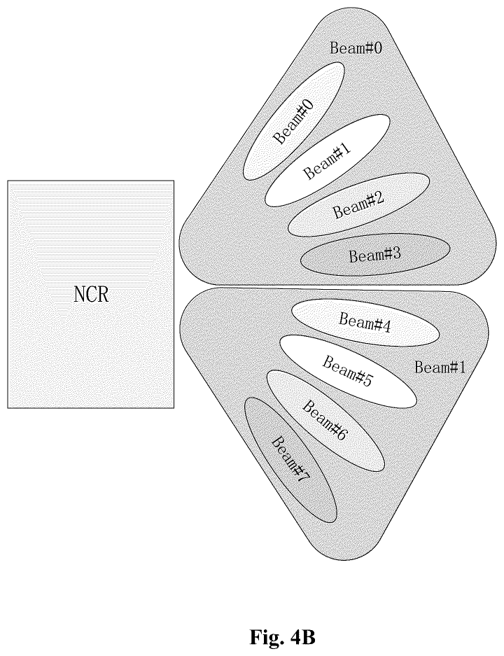

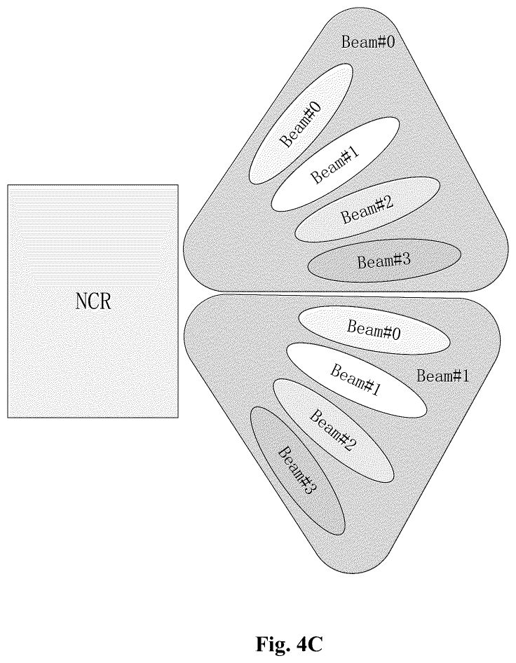

Example 2: the NCR simultaneously supports first beams (wide beams) and second beams (narrow beams). The beams are numbered sequentially, and the numbering may be performed according to spatial relationships. For example, wide beams are numbered first, and then narrow beams are numbered, wherein wide beams with adjacent numbers are spatially adjacent, and narrow beams with adjacent numbers are spatially adjacent. Or, a wide beam and a narrow beam associated with the wide beam are numbered first, and then other wide beams and narrow beams are numbered in the same manner. For example, FIG. 4A is a schematic diagram of the beam indices in the embodiments of this disclosure. As shown in FIG. 4A, the NCR supports 2 wide beams (first beams) and 8 narrow beams (second beams), wherein former 4 narrow beams are associated with a first one of wide beams, and latter 4 narrow beams are associated with a second one of wide beams. All the beams are numbered starting from 0 or 1, such as 0-9 (or 1-10 that are not shown). In numbering, former two may be wide beams, and the rest may be narrow beams, or, beams numbered first and sixth are wide beams, and the rest are narrow beams.

Example 3: the NCR simultaneously supports first beams (wide beams) and second beams (narrow beams). The first beams and the second beams are respectively numbered sequentially, and the numbering may be performed according to spatial relationships, wherein wide beams with adjacent numbers are spatially adjacent, and narrow beams with adjacent numbers are spatially adjacent. For example, FIG. 4B is a schematic diagram of the beam indices in the embodiments of this disclosure. As shown in FIG. 4B, the NCR supports 2 wide beams (first beams) and 8 narrow beams (second beams). The wide beams and the narrow beams are numbered starting from 0 or 1, such as 0-1 (or 1-2 that are not shown) for wide beams and 0-7 (or 1-8 that are not shown) for narrow beams. For example, former 4 narrow beams are associated with a first one of wide beams, and latter 4 narrow beams are associated with a second one of wide beams.

Example 4: the NCR simultaneously supports first beams (wide beams) and second beams (narrow beams). The first beams and the second beams are numbered hierarchically, starting from 0 or 1 respectively, and the numbering may be performed according to spatial relationships. Wide beams with adjacent numbers are spatially adjacent, and narrow beams with adjacent numbers are spatially adjacent. For the wide beams with adjacent numbers, narrow beams with larger numbers with which wide beams with smaller numbers are associated are spatially adjacent to narrow beams with smaller numbers with which wide beams with larger numbers are associated. For example, FIG. 4C is a schematic diagram of the beam indices in the embodiments of this disclosure. As shown in FIG. 4C, the NCR supports 2 wide beams (first beams) and 8 narrow beams (second beams), wherein wide beam are numbered 0-1 (or 1-2 that are not shown), and four narrow beams associated with a first one of wide beams and four narrow beams associated with a second one of wide beams are numbered 0-3 or (or 1-4 that are not shown), respectively.

One dimension is taken as an example in the above indexes; however, the embodiments of this disclosure are not limited thereto, and the indices may also be two-dimensional or three-dimensional. For example, the beams may be arranged in a two-dimensional array, and beams in a horizontal direction and beams in a vertical direction may be numbered separately, and the indices are two-dimensional indices, which shall not be enumerated herein any further.

In some embodiments, a range of beams to which beams that may be numbered correspond may be all beams that may be used by the NCR for forwarding or all beams that the first control information is able to indicate (candidate beams configured by a higher layer parameter of the network device) and/or all beams supported by the NCR, or, in other words, one beam may correspond to one or more beam indices (multiple beam indices are respectively predefined and/or reported by the NCR to the network device and/or configured by the network device). For example, a beam corresponds to a first index and a second index, wherein the first index is an index in all beams supported by the NCR that uniquely identifies the beam, and the second index is an index in all the beams available for forwarding by the NCR or all beams that the first control information is able to indicate (candidate beams configured by the higher layer parameter of the network device) that uniquely identifies the beam.

In the above example, the first control information includes the first information and the second information, one or more access link beams indicated by the second information correspond to the time domain resources indicated by the first information, and when the second information indicates multiple access link beams, the multiple access link beams are of time division or frequency division.

In some embodiments, the first information is carried by one first information field, and the time domain resources indicated by the first information field correspond to one access link beam; the second information is carried by one or more second information fields, which indicate one access link beam, the access link beam corresponding to the time domain resources indicated by the first information field.

Example I: when the first information is carried by multiple (M) second information fields, information related to the beam indicated by different second information fields is different. For example, when two second information fields are included, one of them is used to indicate a beam type (wide beam/narrow beam), and the other is used to indicate an beam index (of the beam of the beam type); or, one of them is used to indicate a beam group identifier, and the other is used to indicate an beam index (of a beam of the beam group); or, one of them is used to indicate an index of a wide beam, and the other is used to indicate an index of a narrow beam (for example, based on above example 3 about the index, specific values may be reserved separately to denote that no wide beam or narrow beam is indicated; for example, based on above example 4 about the index, a specific value is reserved for the second information field indicating only indices of narrow beams to denote that no narrow beam is indicated (or, in other words, the DCI indicates wide beams).

Example II: when one second information field is included, the second information field directly or indirectly indicates a beam index (a first index or a second index) of an access link beam. When the second information field directly indicates, a decimal value of the second information field is equal to an index value of the beam, thereby indicating a corresponding beam. When the second information field indirectly indicates, a decimal value/binary value of the second information field are mapped in an ascending order to index values of beams in an ascending order, thereby indicating corresponding beams. Or, bits in the second information field are mapped in an order from MSBs to LSBs (or vice versa) to index values of beams in an ascending order. If a bit value is 0, no corresponding beam is indicated, and if a bit value is 1, a corresponding beam is indicated (only one bit is 1, and others are 0). For example, for example 1, the second information field may be 0001, indicating a last numbered beam.

In some embodiments, the first information is carried by one first information field, and time domain resources indicated by the first information field correspond to one or more access link beams. The second information is carried by one or more second information fields, the one or more second information fields indicating one or more access link beams, which correspond(s) to the time domain resources indicated by the first information field. Example III: when the second information is carried by multiple (K) second information fields, each second information field indicates one access link beam, and access link beams indicated by multiple second information fields correspond to different parts of the time domain resources (time division) indicated by the first information field according to a predefined rule, or access link beams indicated by multiple second information fields correspond to all of the time domain resources (frequency division) indicated by the first information field, or a mixture of time domain resources.

Example IV: when the second information is carried by multiple (K) second information fields, the K second information fields may be divided into multiple (N) groups of second information fields, each group of second information fields including one or more (M) second information fields. Each group of second information fields indicates one access link beam, and access link beams indicated by multiple groups of second information fields correspond to different parts of the time domain resources (time division) indicated by the first information field according to a predefined rule, or access link beams indicated by multiple groups of second information fields correspond to all of the time domain resources (frequency division) indicated by the first information field, or a mixture of time domain resources. When M second information fields are included in one group of second information fields, information related to beams indicated by different second information fields is different. A specific indication method is as described in example I, which shall not be described herein any further.

In some embodiments, the first information is carried by multiple first information fields, and time domain resources indicated by the multiple first information fields correspond to one or more access link beams. For example, information related to time domain resources indicated by different first information fields is different. For example, the first information is carried by two first information fields, time units indicated by different first information fields are different, and one of first information fields is used to indicate slots, the other is used to indicate symbols; or, information indicated by different first information fields is different, and one of first information fields is used to indicate a starting position, the other is used to indicate a duration. For another example, the first information is carried by three first information fields, which are respectively used to indicate a slot offset, a symbol offset and a duration. Or, for example, time domain resources indicated by different first information fields do not overlap or do not completely overlap. The time domain resources indicated by the multiple first information fields are a union of the time domain resources indicated by the multiple first information fields.

Example V: the first information is carried by multiple first information fields, and the second information is carried by one or more second information fields, the one or more second information fields indicating one access link beam, corresponding to the time domain resources indicated by the multiple first information fields. When the second information is carried by one second information field, the one second information field directly or indirectly indicates the one access link beam. A specific indication method is as described in example II, which shall not be described herein any further. When the second information is carried by multiple second information fields, information related to the beam indicated by different second information fields is different. A specific indication method is as described in example I, which shall not be described herein any further.

Example VI: the first information is carried by multiple first information fields, and the second information is carried by one or more second information fields, the one or more second information fields indicating one or more access link beams, corresponding to the time domain resources indicated by the multiple first information fields. For example, when the second information is carried by multiple (K) second information fields, each second information field indicates one access link beam, and the first information fields correspond to the second information fields one by one, that is, an access link beam indicated by one second information field is applied to a time domain resource indicated by a first information field to which it corresponds. For another example, when the second information is carried by multiple (K) second information fields, the K second information fields may be divided into multiple (N) groups of second information fields, each group of second information fields including one or more (M) second information fields, each group of second information fields indicating one access link beam, and the first information fields corresponding the groups of second information fields one by one; access link beams indicated by one group of second information fields are applied to a time domain resource indicated by a first information field to which it corresponds. When M second information fields are included in one group of second information fields, information related to the beam indicated by different second information fields is different. A specific indication method is as described in example I, which shall not be described herein any further.

In some embodiments, the first control information may be RRC signaling.

In some embodiments, when the first control information is RRC signaling, the same information element (ExemplarIE_1 in the example) or the same field (exampleField_1 in the example) in the RRC signaling is used to configure the access link beam in different cases, or is used to configure the forwarding unit to be in the first state or the second state or the third state.

Example 1: ExampleIE_1 or exampleField_1 may be expressed as follows by using an ASN.1 data format:

```
ExampleIE_1/exampleField_1 ::= SEQUENCE {
    aField  FFS (e. g. INTEGER (0..9) or Element_X) ,
    OPTIONAL, Cond XYZ1
    anotherField FFS (e. g. Element_2) ,
    ...
```

Wherein, aField is used to configure an access link beam, INTEGER (0 . . . 9) may be an index of the beam (corresponding to the second information), or may be the number of the beams, etc., and optionally, it may further include Element_X, which is used to configure a beam pattern; however, the embodiments of this disclosure are not limited thereto. Regarding aField, it may be present or may not be present (the first control information includes or does not include the second information), that is, aField is conditionally present. The condition XYZ1 includes that: aField is optional present for FR2 (or FR2-1); aField is absent for FR1; or, aField is mandatory present for FR2 (or FR2-1); aField is absent for FR1; or, aField is mandatory present for FR2 (or FR2-1); aField is optional present for FR1.

Wherein, in the case where aField is present, anotherField is used to configure the time domain resource corresponding to the access link beam (configured by corresponding aField), thereby implicitly indicating that the NCR-Fwd is in the first state in the time domain resource. In the case where aField is absent, anotherField is used to configure the time domain resource of the forwarding unit in the first state or the second state or the third state. Element_2 includes the first information used to indicate a time domain resource, and Element_2 includes one or more first information fields.

Example 2: ExampleIE_1 or exampleField_1 may be expressed by using an ASN.1 data format as: ExampleIE_1 or exampleField_1 is used to configure an access link beam, or is used to configure the forwarding unit to be in the first state or the second state or the third state.

```
ExampleIE_1/exampleField_1 ::= ::= SEQUENCE {
      elementsToAddModList SEQUENCE (SIZE (1..maxNrofElements)) OF
Element_1 OPTIONAL,
      elementsToReleaseList SEQUENCE (SIZE (1..maxNrofElements)) OF
ElementId OPTIONAL, -- Need N
      ...
Element_1 ::= SEQUENCE {
      elementId ElementId,
      aField  FFS (e. g. INTEGER (0..9)) or Element_X,
    OPTIONAL, Cond XYZ1
      anotherField FFS (e. g. Element_2) ,
      ...
}
ElementId ::= INTEGER (0..maxNrofElements-1)
maxNrofElements INTEGER ::= 8
maxNrofElements-1 INTEGER ::= 7
```

Wherein, Element_1 is used to configure one or more access link beams and time domain resources to which the one or more access link beams correspond, or is used to configure the time domain resources of the forwarding unit in the first state or the second state or the third state.

Wherein, aField is used to configure an access link beam, INTEGER (0 . . . 9) may be an index of an beam (corresponding to the second information), or may be the number of the beams, etc., and optionally, it may further include Element_X, which is used to configure a beam pattern; however, the embodiments of this disclosure are not limited thereto. Regarding aField, it may be present or may not be present (the first control information includes or does not include the second information), that is, aField is conditionally present. The condition XYZ1 includes that: aField is optional present for FR2 (or FR2-1); aField is absent for FR1; or, aField is mandatory present for FR2 (or FR2-1); aField is absent for FR1; or, aField is mandatory present for FR2 (or FR2-1); aField is optional present for FR1.

Wherein, in the case where aField is present, anotherField is used to configure the time domain resource corresponding to the access link beam (configured by corresponding aField), thereby implicitly indicating that the NCR-Fwd is in the first state in the time domain resource. In the case where aField is absent, anotherField is used to configure the time domain resource of the forwarding unit in the first state or the second state or the third state. Element_2 includes the first information used to indicate time domain resources, and Element_2 includes one or more first information fields.

Example 3: ExampleIE_1 or exampleField_1 may be expressed by using an ASN.1 data format as: ExampleIE_1 or exampleField_1 is used to configure an access link beam, or is used to configure the forwarding unit to be in the first state or the second state or the third state.

```
ExampleIE_1/exampleField_1 ::= SEQUENCE {
      elementList SEQUENCE (SIZE (1..maxNrofElements)) OF
Element_1 OPTIONAL, -- Need M
Element_1 ::= SEQUENCE {
      aField FFS (e. g. INTEGER (0..9)) or Element_X,
    OPTIONAL, Cond XYZ1
      anotherField FFS (e. g. Element_2) ,
      ...
}
maxNrofElements INTEGER ::= 8
maxNrofElements-1 INTEGER ::= 7
-- TAG EXAMPLE_LISTS_STOP
-- /example/ ASN1STOP
```

Wherein, Element_1 is used to configure one or more access link beams and time domain resources to which the one or more access link beams correspond, or is used to configure the time domain resources of the forwarding unit in the first state or the second state or the third state.

Wherein, aField is used to configure an access link beam, INTEGER (0 . . . 9) may be an index of an beam (corresponding to the second information), or may be the number of the beams, etc., and optionally, it may further include Element_X, which is used to configure a beam pattern; however, the embodiments of this disclosure are not limited thereto. Regarding aField, it may be present or may not be present (the first control information includes or does not include the second information), that is, aField is conditionally present. The condition XYZ1 includes that: aField is optional present for FR2 (or FR2-1); aField is absent for FR1; or, aField is mandatory present for FR2 (or FR2-1); aField is absent for FR1; or, aField is mandatory present for FR2 (or FR2-1); aField is optional present for FR1.

Wherein, in the case where aField is present, anotherField is used to configure the time domain resource corresponding to the access link beam (configured by corresponding aField), thereby implicitly indicating that the NCR-Fwd is in the first state in the time domain resource. In the case where aField is absent, anotherField is used to configure the time domain resource of the forwarding unit in the first state or the second state or the third state. Element_2 includes the first information used to indicate a time domain resource, and Element_2 includes one or more first information fields.

In some embodiments, when the first control information is RRC signaling, different information elements or different fields in the RRC signaling are used to configure access link beams, or are used to configure the forwarding unit to be in the first state or the second state or the third state. Different information elements (ExampleIE_2 and ExampleIE_3 in the example) or different fields (exampleField_2 and exampleField_3 in the example) share identical information elements (Element_1 or Element_2 in the example) to configure the time domain resources.

Example 4: ExampleIE_2 or exampleField_2 and ExampleIE_3 or exampleField_3 may be expressed as follows by using an ASN.1 data format:

```
ExampleIE_2/exampleField_2 ::= SEQUENCE {
      aField FFS (e. g. INTEGER (0..9)) or Element_X,
    OPTIONAL,
      anotherField FFS (e. g. Element_2) ,
    ...
    }
    } OPTIONAL, Cond XYZ1
ExampleIE_3/exampleField_3 ::= SEQUENCE {
    aField FFS (e. g. Element_2) ,
    ...
```

Wherein, ExampleIE_2 or exampleField_2 is used to configure an access link beam, and ExampleIE_3 or exampleField_3 is used to configure the forwarding unit to be in the first state or the second state or the third state. Regarding ExampleIE_2 or exampleField_2, it may be present or absent (the first control information includes or does not include the second information), that is, it is conditionally present. The condition XYZ1 includes that: it is optional present for FR2 (or FR2-1); it is absent for FR1; or, it is mandatory present for FR2 (or FR2-1); it is absent for FR1; or, it is mandatory present for FR2 (or FR2-1); it is optional present for FR1.

Example 5: ExampleIE_2 or exampleField_2 and ExampleIE_3 or exampleField_3 may be expressed as follows by using an ASN.1 data format:

```
ExampleIE_2/exampleField_2 Element_1 OPTIONAL,
Cond XYZ1
ExampleIE_3/exampleField_3 Element_1
Element_1 ::= SEQUENCE {
      aField FFS (e. g. INTEGER (0..9)) or Element_X,
    OPTIONAL, Cond XYZ2
      anotherField FFS (e. g. Element_2) ,
      ...
}
```

Wherein, ExampleIE_2 or exampleField_2 is used to configure an access link beam, and ExampleIE_3 or exampleField_3 is used to configure the forwarding unit to be in the first state or the second state or the third state. Regarding ExampleIE_2 or exampleField_2 (corresponding to the second information), it may be present or absent (the first control information includes or does not include the second information), that is, it is conditionally present. The condition XYZ1 includes that: it is optional present for FR2 (or FR2-1); it is absent for FR1; or, it is mandatory present for FR2 (or FR2-1),; it is absent for FR1; or, it is mandatory present for FR2 (or FR2-1); it is optional present for FR1. Reference may be made to example 6 for explanations of Element_1, which shall not be repeated herein any further.

Example 6: ExampleIE_2 or exampleField_2 and ExampleIE_3 or exampleField_3 may be expressed as follows by using an ASN.1 data format.

```
-- /example/ ASN1START
ExampleIE_2/exampleField_2 ::= SEQUENCE {
      elementsToAddModList SEQUENCE (SIZE (1..maxNrofElements_1)) OF
Element_1 OPTIONAL,
      elementsToReleaseList SEQUENCE (SIZE (1..maxNrofElements_1)) OF
ElementId OPTIONAL, -- Need N
      ...
} OPTIONAL, Cond XYZ1
ExampleIE_3/exampleField_3::= SEQUENCE {
      elementsToAddModList SEQUENCE (SIZE (1..maxNrofElements_2)) OF
Element_1 OPTIONAL,
      elementsToReleaseList SEQUENCE (SIZE (1..maxNrofElements_2)) OF
ElementId OPTIONAL, -- Need N
      ...
}
Element_1 ::= SEQUENCE {
      elementId ElementId,
      aField FFS (e. g. INTEGER (0..9)) or Element_X,
    OPTIONAL, Cond XYZ2
      anotherField FFS (e. g. Element_2) ,
      ...
}
ElementId ::= INTEGER (0..maxNrofElements-1)
maxNrofElements_1 INTEGER ::= 8
maxNrofElements_1-1 INTEGER ::= 7
maxNrofElements_2 INTEGER ::= 8
maxNrofElements_2-1 INTEGER ::= 7
-- /example/ ASN1STOP
```

Wherein, ExampleIE_2 or exampleField_2 is used to configure an access link beam (corresponding to the second information), and ExampleIE_3 or exampleField_3 is used to configure the forwarding unit to be in the first state or the second state or the third state. Regarding ExampleIE_2 or exampleField_2, it may be present or absent (the first control information includes or does not include the second information), that is, it is conditionally present. The condition XYZ1 includes that: it is optional present for FR2 (or FR2-1); it is absent for FR1; or, it is mandatory present for FR2 (or FR2-1); it is absent for FR1; or, it is mandatory present for FR2 (or FR2-1); it is optional present for FR1.

Wherein, Element_1 is used to configure one or more access link beams and time domain resources to which the one or more access link beams correspond, or is used to configure the time domain resources of the forwarding unit in the first state or the second state or the third state.

Wherein, aField is used to configure an access link beam, INTEGER (0 . . . 9) may be an index of the beam, or may be the number of the beams, etc., and optionally, it may further include Element_X, which is used to configure a beam pattern; however, the embodiments of this disclosure are not limited thereto. Regarding aField, it may be present or may not be present, that is, aField is conditionally present. The condition XYZ2 includes that: it is mandatory present for ExampleIE_2 or exampleField_2, and it is absent for ExampleIE_3 or exampleField_3.

Wherein, in the case where aField is present, anotherField is used to configure the time domain resource corresponding to the access link beam (configured by corresponding aField), thereby implicitly indicating that the NCR-Fwd is in the first state in the time domain resource. In the case where aField is absent, anotherField is used to configure the time domain resource of the forwarding unit in the first state or the second state or the third state. Element_2 includes the first information used to indicate a time domain resource, and Element_2 includes one or more first information fields.

Element_2 may be expressed as follows by using an ASN.1 data format:

```
Element_2 ::= SEQUENCE {
    field_1
    field_2
    field_3
    ...
```

Wherein, field_1 is used to configure a period and/or an offset (periodicityAndOffset) of a time domain resource, field_2 is used to configure a duration in a period, and field_3 is used to configure slots and/or symbols in a duration, such as indicating an slot index, a starting slot index, a starting symbol index, the number of the slots, and the number of the symbols, wherein the slot index is an index in 10 ms (one frame) or 1 ms (one subframe), the symbol index is an index within 10 ms (one frame) or 1 ms (one subframe) or one slot, the number of slots is the number of slots in the duration, and the number of symbols is the number of symbols in the duration or the slot.

In some embodiments, the first control information may be DCI, which may be DCI format X_Y. For example, the DCI format X_Y may be an existing DCI format (such as DCI format 1_0/1_1/1_2/0-0/0_1/0_2/2_2, etc.), or a DCI format newly introduced for the NCR.

In some embodiments, the DCI may be unicast/dedicated or group common.

In some embodiments, CRC of the DCI is scrambled by a first radio network temporary identifier (RNTI) or a second RNTI. The first RNTI includes, for example, RNTI types that may also be used by/configured for a non-NCR, such as a first C-RNTI, a first MCS-C-RNTI, and an SFI-RNTI. The second RNTI includes, for example, an NCR-specific RNTI (such as an NCR-RNTI or a second C-RNTI or a second MCS-C-RNTI), that is, a non-NCR is not able to use/is not configured with the second RNTI.

In some embodiments, the NCR (such as an NCR-MT) may be configured to monitor DCI format X_Y in a user-specific search space (USS) and/or a common search space (CSS). For example, if DCI format X_Y is unicast or dedicated, the NCR may be configured to monitor the DCI format in a USS, and a corresponding RNTI used to scramble CRC is, for example, the first C-RNTI, or the NCR-RNTI, or the second C-RNTI, the second MCS-C-RNTI. If DCI format X_Y is group common, the NCR may be configured to monitor the DCI format in a CSS, such as a Type3-PDCCH CSS set, and a corresponding RNTI used for scrambling CRC is the SFI-RNTI, or the NCR-RNTI, or the second C-RNTI, or the second MCS-C-RNTI.

For example, the DCI includes one or more first information fields, the first information field including a time domain resource allocation information field, one TDRA information field indicating a row of TDRA configuration via a row index. A time domain resource allocation (TDRA) table (or a TDRA table in brief) includes at least one row, and for ease of description, one row is referred to as a TDRA configuration, that is, the TDRA table includes at least one TDRA configuration. A TDRA configuration includes at least one time domain resource configuration, the time domain resource configuration at least including a symbol position (starting position symbol+length) configuration in a slot. In addition, optionally, a TDRA configuration may further include at least one slot offset KO configuration, and the TDRA configuration may further or may not include other information (such as a mapping type), and the embodiments of this disclosure are not limited thereto. Wherein, regarding the symbol position configuration in the slot, it includes, for example, a start and length indicator (SLIV), which corresponds to a valid combination of a starting symbol(S) and a length (L), or, for example, it corresponds to a starting symbol configuration and a length configuration, the starting symbol configuration and the length configuration are a valid combination.

In some embodiments, a first time position associated with the first control information may be a slot or a last slot or a last symbol where a time domain resource or physical channel (PDCCH/PDSCH) carrying the first control information is located, or, the first time position may be a subframe or a slot or a last slot or a last symbol where HARQ-ACK information corresponding to which the first control information or a physical channel (PDCCH/PDSCH) carrying the first control information is located. For example, when the first control information is DCI, the DCI is carried by the PDCCH, and the first time position may be subframe or a slot or a last slot or a last symbol where the PDCCH carrying the DCI is located, or, the first time position may be a subframe or a slot or a last slot or a last symbol where HARQ-ACK feedback (PUCCH/PUSCH where HARQ-ACK feedback is located) corresponding to the DCI or the PDCCH carrying the DCI is located. For example, the first control information is a MAC CE, which may be carried by a PDSCH. The first time position is a subframe or a slot or a last slot or a last symbol where HARQ-ACK feedback (PUCCH/PUSCH where HARQ-ACK feedback is located) corresponding to a PDSCH carrying the MAC CE is located.

In some embodiments, a second time position of the time domain resource indicated by the first information is a subframe or a slot or a first one of slots or a first one of symbols where the time domain resource indicated by the first information is located.

In some embodiments, if a state of the repeater in receiving the first control information or a state of the repeater before the first information indicates the time domain resource is different from a state of the time domain resource indicated by the first information, switching of the states also needs a transient period, and furthermore, times of other processing behaviors of the repeater (such as beam switching) and/or a time (decoding) needed in receiving the first control information, etc., may be included. Hence, a first interval between the first time position and the second time position of the time domain resource indicated by the first information is greater than or not less than a first predetermined value or a second predetermined value, the first predetermined value being greater than the second predetermined value. Following description shall be given by taking switching from the third state or the second state to the first state as an example.

In some embodiments, the forwarding unit is in the third state when the mobile termination receives the first control information, or the forwarding unit is in the third state before the time domain resource indicated by the first information, and is in the first state in the time domain resource indicated by the first information, and the first interval is greater than or not less than the first predetermined value.

For example, the first predetermined value includes a time needed by the forwarding unit in switching from the third state to the first state, wherein the time needed in switching from the third state to the first state includes or does not include a time needed in beam switching. For example, when the first control information includes the second information, the time needed in switching from the third state to the first state includes the time needed in beam switching, and when the first control information does not include the second information, the time needed in switching from the third state to the first state does not include the time needed in beam switching. Optionally, the first predetermined value may further include or not include a time needed by the mobile termination in receiving the first control information.

Or, for example, the first predetermined value includes a time needed by the forwarding unit in switching from the third state to the second state, and optionally, the first predetermined value may further include or may not include the time needed by the mobile termination in receiving the first control information.

Or, for example, the first predetermined value includes the time needed in switching from the third state to the second state and a time needed in switching from the second state to the first state by the forwarding unit, wherein the time needed in switching from the second state to the first state includes or does not include the time needed in beam switching. For example, when the first control information includes the second information, the time needed in switching from the second state to the first state includes the time needed in beam switching, and when the first control information does not include the second information, the time needed in switching from the second state to the first state does not include the time needed in beam switching. Optionally, the first predetermined value may further include or may not include the time needed by the mobile termination in receiving the first control information.

Or, for example, the first predetermined value includes the time needed by the forwarding unit in switching from the third state to the second state and the time needed in beam switching. Optionally, the first predetermined value may further include or may not include the time needed by the mobile termination in receiving the first control information.

In some embodiments, the forwarding unit is in the second state in receiving the first control information, or the forwarding unit is in the second state before the time domain resource indicated by the first information, and is in the first state in the time domain resource indicated by the first information, and he first interval is greater than or not less than the second predetermined value.

For example, the second predetermined value includes a time needed by the forwarding unit in switching from the second state to the first state, wherein the time needed in switching from the second state to the first state includes or does not include the time needed in beam switching. For example, when the first control information includes the second information, the time needed in switching from the second state to the first state includes the time needed in beam switching, and when the first control information does not include the second information, the time needed in switching from the second state to the first state does not include the time needed in beam switching. Optionally, the second predetermined value may further include or not include the time needed by the mobile termination in receiving the first control information.

Or, for example, the second predetermined value includes the time needed in beam switching. Optionally, the second predetermined value may further or may not include the time needed by the mobile termination in receiving the first control information.

The above description is given by taking switching from the third state or the second state to the first state as an example, and implementations of the repeater in switching from the first state to the third state and from the first state to the second state are similar thereto. When the repeater switches from the second state to the third state or from the third state to the second state, for example, the forwarding unit is in the third state in receiving the first control information, or the forwarding unit is in the third state before the time domain resource indicated by the first information, and is in the second state in the time domain resource indicated by the first information, and the first interval is greater than or not less than a fifth predetermined value. For example, the fifth predetermined value includes the time needed in switching from the third state to the second state, and optionally, the fifth predetermined value may further or may not include the time needed by the mobile termination in receiving the first control information.

Implementation of the first interval is described above by taking state switching as an example, and implementation of the first interval (hereinafter referred to as a second interval) shall be described below by taking whether the first control information includes the second information as an example.

In some embodiments, a second interval between a third time position related to the first control information and a fourth time position of the time domain resource indicated by the first information is greater than or not less than a third predetermined value or a fourth predetermined value, the third predetermined value being greater than the fourth predetermined value. Reference may be made to the first time position for the third time position, and reference may be made to the second time position for the fourth time position, which shall not be repeated herein any further. In some embodiments, the first control information includes the second information used to indicate one or more access link beams, and the second interval is greater than or not less than the third predetermined value.

For example, the third predetermined value includes the time needed by the forwarding unit in switching from the third state to the first state, wherein the time needed in switching from the third state to the first state includes the time needed in beam switching, and optionally, the third predetermined value may further include or may not include the time needed by the mobile termination in receiving the first control information.

Or, for example, the third predetermined value includes the time needed in switching from the third state to the second state and the time needed in switching from the second state to the first state by the forwarding unit, wherein the time needed in switching from the second state to the first state includes the time needed in beam switching. Optionally, the third predetermined value may further include or may not include the time needed by the mobile termination in receiving the first control information.

Or, for example, the third predetermined value includes the time needed by the forwarding unit in switching from the third state to the second state and the time needed in beam switching. Optionally, the third predetermined value may further include or may not include the time needed by the mobile termination in receiving the first control information. Or, for example, the third predetermined value includes the time needed by the forwarding unit in switching from the second state to the first state, wherein the time needed in switching from the second state to the first state includes the time needed in beam switching. Optionally, the third predetermined value may further include or may not include the time needed by the mobile termination in receiving the first control information.

Or, for example, the third predetermined value includes the time needed in beam switching. Optionally, the third predetermined value may further include or may not include the time needed by the mobile termination in receiving the first control information.

In some embodiments, the first control information does not include the second information indicating one or more access link beams, and the second interval is greater than or not less than the fourth predetermined value.

For example, the fourth predetermined value includes the time needed by the forwarding unit in switching from the third state to the first state, wherein the time needed in switching from the third state to the first state does not include the time needed in beam switching, and optionally, the fourth predetermined value may further include or may not include the time needed by the mobile termination in receiving the first control information.

Or, for example, the fourth predetermined value includes the time needed by the forwarding unit in switching from the third state to the second state, and optionally, the fourth predetermined value may further include or may not include the time needed by the mobile termination in receiving the first control information.

Or, for example, the fourth predetermined value includes the time needed in switching from the third state to the second state and the time needed in switching from the second state to the first state by the forwarding unit, wherein the time needed in switching from the second state to the first state does not include the time needed in beam switching. Optionally, the fourth predetermined value may further include or may not include the time needed by the mobile termination in receiving the first control information.

Or, for example, the fourth predetermined value includes the time needed by the forwarding unit in switching from the second state to the first state, wherein the time needed in switching from the second state to the first state does not include the time needed in beam switching. Optionally, the fourth predetermined value may further include or may not include the time needed by the mobile termination in receiving the first control information.

Or, for example, the fourth predetermined value includes the time needed in beam switching. Optionally, the fourth predetermined value may further include or may not include the time needed by the mobile termination in receiving the first control information.

In the above examples, whether the predetermined values include the time needed by the mobile termination in receiving the first control information may be determined according to whether HARQ-ACK for the first control information is fed back.

For example, when the HARQ-ACK is fed back, the first (third) time position is based on a position of the HARQ-ACK (such as a slot or a last slot or a last symbol where HARQ-ACK information corresponding to DCI or an MAC CE is located), and the predetermined values do not need to include the time needed by the mobile termination in receiving the first control information; and when the first (third) time position is based on the first control information (a slot or a last slot or a last symbol where a PDCCH carrying the DCI is located), the predetermined values need to include the time needed by the mobile termination in receiving the first control information.

For example, when the HARQ-ACK is not fed back, the first (third) time position is based on the first control information (the slot or the last slot or the last symbol where the PDCCH carrying the DCI is located), the predetermined values need to include the time needed by the mobile termination in receiving the first control information.

How to determine whether to feed back the HARQ-ACK information shall be described below.

In some embodiments, the mobile termination of the repeater transmits or does not transmit the HARQ-ACK information to which the first control information corresponds.

In some embodiments, whether the mobile termination transmits the HARQ-ACK information to which the first control information corresponds is related to capability of the repeater and/or a higher layer parameter configuration, or, in other words, whether HARQ-ACK feedback for the first control information is supported is related to capability of the repeater and/or a higher layer parameter configuration. For example, the first control information may be DCI.

For example, as to being related to capability, assuming that the first control information is DCI (DCI format X_Y), the NCR reports whether it supports or does not support HARQ-ACK feedback for DCI format X_Y to the base station. If that the NCR supports the HARQ-ACK is reported, the NCR transmits corresponding HARQ-ACK information (ACK) to the base station after receiving DCI format X_Y; otherwise, the NCR does not transmit corresponding HARQ-ACK information (ACK) to the base station after receiving DCI format X_Y. In some cases, the NCR does not support the HARQ-ACK by default, hence, the NCR reports that it supports the HARQ-ACK feedback for DCI format X_Y to the base station only in a case where it supports the HARQ-ACK feedback; otherwise, it does not need to report.

For example, as to being related to a higher layer parameter configuration, assuming that the first control information is DCI (DCI format X_Y), the higher layer parameter is an information field of RRC signaling, the information field being (directly or indirectly) used to configure whether the NCR performs HARQ-ACK feedback for DCI format X_Y. If the NCR is configured to perform HARQ-ACK feedback for DCI format X_Y, the NCR transmits corresponding HARQ-ACK information (ACK) to the base station after receiving DCI format X_Y; otherwise, the NCR does not transmit corresponding HARQ-ACK information (ACK) to the base station after receiving DCI format X_Y. For example, the higher layer parameter may be a 1-bit information element. When the higher layer parameter (such as being carried by RRC) is configured with a bit value of 1, the HARQ-ACK feedback is for the first control information, and when the higher layer parameter (such as being carried by RRC) is configured with a bit value of 0, the HARQ-ACK feedback is not for the first control information. In general, as described above, the capability of the NCR does not support the HARQ-ACK feedback, and the higher layer parameter shall not be configured to perform HARQ-ACK feedback for DCI format X_Y.

In some embodiments, the mobile termination of the repeater transmits the HARQ-ACK information to which the first control information corresponds, and the starting position of the time domain resource indicated by the first information is after (ensuring reliability) or before (reducing latency) or identical to an ending position of a time domain resource used to transmit the HARQ-ACK information. Wherein, a time domain position for transmitting the HARQ-ACK information may be predefined or may be indicated by the network device, and taking delay and reliability factors into account, the network device may configure the starting position of the time domain resource indicated by the first information.

In some embodiments, the mobile termination of the repeater transmits the HARQ-ACK information to which the first control information corresponds, and a position of the time domain resource indicated by the first information is unrelated to a position of the time domain resource used to transmit the HARQ-ACK information. Or, in other words, the position of the time domain resource indicated by the first information is not limited to the position of the time domain resource used to transmit the HARQ-ACK information. Or, in other words, the network device does not need to take the position of the time domain resource used to transmit the HARQ-ACK information into account in configuring the position of the time domain resource indicated by the first information. For example, the NCR transmits corresponding HARQ-ACK information after receiving the first control information or the DCI/PDCCH/PDSCH used to carry the first control information, and the first (third) time position to which the first control information is related is the slot or the last slot or the last symbol where the time domain resource or physical channel (PDCCH/PDSCH) carrying the first control information is located. For example, when the first control information is DCI, the DCI is carried by a PDCCH, and the first (third) time position may be a subframe or a slot or a last slot or a last symbol where the PDCCH carrying the DCI is located. Hence, a sequential order of the position of the time domain resource transmitting the HARQ-ACK information and the position of the time domain resource indicated by the first information in the first control information is not limited, that is, the position of the time domain resource indicated by the first information in the first control information is not limited by the position of the time domain resource used to transmit the HARQ-ACK information, and vice versa.

The above implementations only illustrate the embodiments of this disclosure. However, this disclosure is not limited thereto, and appropriate variants may be made on the basis of these implementations. For example, the above implementations may be executed separately, or one or more of them may be executed in a combined manner.

According to the embodiments of this disclosure, ON/OFF of the repeater may be controlled by the first control information, ensuring that the time domain resources to which the ON state of repeater corresponds match with the time domain resources for data transmission between the network device and the terminal equipment. This not only conserves power consumption of the repeater, but also reduces interference to other devices in the network, thereby enhancing network throughput.

### Embodiments of a Second Aspect

The embodiments of this disclosure provide a repeater. The repeater may be, for example, the NCR as described above, or a network device or terminal equipment having a function of forwarding, or one or some components or assemblies configured in the NCR or the network device or the terminal equipment.

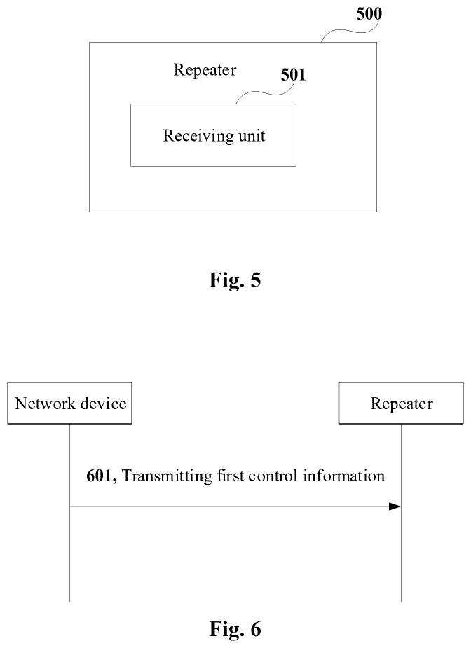

FIG. 5 is a schematic diagram of the repeater of the embodiments of this disclosure. As a principle of the repeater for solving problems is similar to that of the method in the embodiments of the first aspect, reference may be made to the implementation of the method described in the embodiments of the first aspect for implementation of the repeater, with identical or related contents being not going to be described herein any further.

As shown in FIG. 5, the repeater 500 includes:

a receiving unit 501 configured to receive first control information at a mobile termination of the repeater, the first control information at least including first information for indicating a time domain resource,

a forwarding unit of the repeater being in a first state, or a second state, or a third state within the time domain resource indicated by the first information.

Reference may be made to the embodiments of the first aspect for implementations of the first state, the second state and the third state, and reference may be made to the embodiments of the first aspect for implementation of the first control information, which shall not be described herein any further.

Furthermore, for the sake of simplicity, connection relationships between the components or modules or signal profiles thereof are only illustrated in FIG. 5. However, it should be understood by those skilled in the art that such related techniques as bus connection, etc., may be adopted. And the above components or modules may be implemented by hardware, such as a processor, a memory, a transmitter, and a receiver, etc., which are not limited in the embodiments of this disclosure.

The above implementations only illustrate the embodiments of this disclosure. However, this disclosure is not limited thereto, and appropriate variants may be made on the basis of these implementations. For example, the above implementations may be executed separately, or one or more of them may be executed in a combined manner.

According to the embodiments of this disclosure, ON/OFF of the repeater may be controlled by the first control information, ensuring that the time domain resources to which the ON state of repeater corresponds match with the time domain resources for data transmission between the network device and the terminal equipment. This not only conserves power consumption of the repeater, but also reduces interference to other devices in the network, thereby enhancing network throughput.

### Embodiments of a Third Aspect

The embodiments of this disclosure provide an information indication method, which shall be described from a side of a network device, with contents identical to those in the embodiments of the first aspect being not going to be described herein any further.

FIG. 6 is a schematic diagram of the information indication method of the embodiments of this disclosure. As shown in FIG. 6, the method includes:

601: the network device transmits first control information to a repeater, the first control information at least including first information for indicating a time domain resource, and/or transmitting or not transmitting second control information, the second control information being used to indicate that a forwarding unit forwards signals within a time domain resource. Reference may be made to the embodiments of the first aspect for implementations of the first control information and the second control information, which shall not be described herein any further.

It should be noted that FIG. 6 only schematically illustrates the embodiments of this disclosure; however, this disclosure is not limited thereto. For example, an order of execution of the steps may be appropriately adjusted, and furthermore, some other steps may be added, or some steps therein may be reduced. And appropriate variants may be made by those skilled in the art according to the above contents, without being limited to what is contained in FIG. 6.

The steps or processes related to this disclosure are only described above; however, this disclosure is not limited thereto. The method of the embodiments of this disclosure may also include other steps or processes, and reference may be made to relevant techniques for specific contents of these steps or processes.

The above implementations only illustrate the embodiments of this disclosure. However, this disclosure is not limited thereto, and appropriate variants may be made on the basis of these implementations. For example, the above implementations may be executed separately, or one or more of them may be executed in a combined manner.

According to the embodiments of this disclosure, ON/OFF of the repeater may be controlled by the first control information, ensuring that the time domain resources to which the ON state of repeater corresponds match with the time domain resources for data transmission between the network device and the terminal equipment. This not only conserves power consumption of the repeater, but also reduces interference to other devices in the network, thereby enhancing network throughput.

### Embodiments of a Fourth Aspect

The embodiments of this disclosure provide a network device.

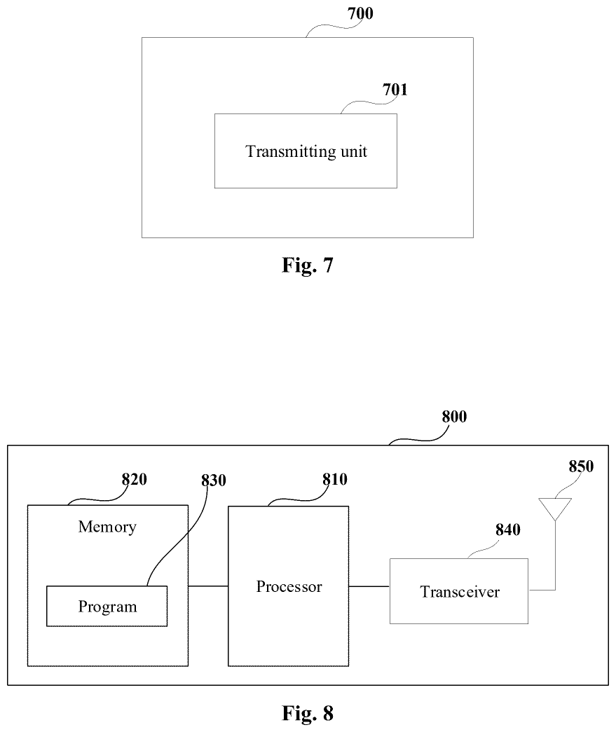

FIG. 7 is a schematic diagram of the network device of the embodiments of this disclosure. As a principle of the network device for solving problems is similar to that of the method in the embodiments of the third aspect, reference may be made to the implementation of the method described in the embodiments of the third aspect for implementation of the network device, with identical or related contents being not going to be described herein any further.

As shown in FIG. 7, the network device 700 of the embodiments of this disclosure includes:

a transmitting unit 701 configured to transmit first control information to a repeater, the first control information at least including first information for indicating a time domain resource, and/or transmit or not to transmit second control information, the second control information being used to indicate that a forwarding unit forwards signals within a time domain resource. Reference may be made to the embodiments of the first aspect for implementations of the first control information and the second control information, which shall not be described herein any further.

It should be noted that the components or modules related to this disclosure are only described above. However, this disclosure is not limited thereto, and the network device 700 of the embodiments of this disclosure may further include other components or modules, and reference may be made to related techniques for particulars of these components or modules.

Furthermore, for the sake of simplicity, connection relationships between the components or modules or signal profiles thereof are only illustrated in FIG. 7. However, it should be understood by those skilled in the art that such related techniques as bus connection, etc., may be adopted. And the above components or modules may be implemented by hardware, such as a processor, a memory, a transmitter, and a receiver, etc., which are not limited in the embodiments of this disclosure.

The above implementations only illustrate the embodiments of this disclosure. However, this disclosure is not limited thereto, and appropriate variants may be made on the basis of these implementations. For example, the above implementations may be executed separately, or one or more of them may be executed in a combined manner.

According to the embodiments of this disclosure, ON/OFF of the repeater may be controlled by the first control information, ensuring that the time domain resources to which the ON state of repeater corresponds match with the time domain resources for data transmission between the network device and the terminal equipment. This not only conserves power consumption of the repeater, but also reduces interference to other devices in the network, thereby enhancing network throughput.

### Embodiments of a Fifth Aspect

The embodiments of this disclosure provide a communication system. FIG. 1 is a schematic diagram of the communication system of the embodiments of this disclosure. As shown in FIG. 1, the communication system 100 includes a network device 101, a repeater 102 and a terminal equipment 103. For the sake of simplicity, description is given in FIG. 1 by taking one network device, one repeater and two terminal equipments only as an example; however, the embodiments of this disclosure are not limited thereto.

In the embodiments of this disclosure, existing traffics or traffics that may be implemented in the future may be performed between the network device 101 and the terminal equipment 103. For example, such traffics may include but not limited to enhanced mobile broadband (eMBB), massive machine type communication (mMTC), ultra-reliable and low-latency communication (URLLC), and vehicle to everything (V2X) communication, etc. The repeater 102 is configured to execute the information indication method in the embodiments of the first aspect, and the network device 101 is configured to execute the information indication method in the embodiments of the third aspect, contents of which being incorporated herein, which shall not be repeated herein any further.

The embodiments of this disclosure further provide an electronic device, which may be, for example, a repeater or a network device.

FIG. 8 is a schematic diagram of a structure of the electronic device of the embodiments of this disclosure. As shown in FIG. 8, the electronic device 800 may include a processor 810 (such as a central processing unit (CPU)) and a memory 820, the memory 820 being coupled to the processor 810. Wherein, the memory 820 may store various data, and furthermore, it may store a program 830 for information processing, and execute the program 830 under control of the processor 810.

For example, the processor 810 may be configured to execute a program to execute the information indication method described in the embodiments of the first aspect.

For another example, the processor 810 may be configured to execute a program to execute the information indication method described in the embodiments of the third aspect.

Furthermore, as shown in FIG. 8, the electronic device 800 may include a transceiver 840, and an antenna 850, etc. Wherein, functions of the above components are similar to those in the related art, and shall not be described herein any further. It should be noted that the electronic device 800 does not necessarily include all the parts shown in FIG. 8, and furthermore, the electronic device 800 may include parts not shown in FIG. 8, and the related art may be referred to.

Embodiments of this disclosure provide a computer program, which, when executed in a repeater, will cause a computer to carry out the information indication method described in the embodiments of the first aspect in the repeater.

Embodiments of this disclosure provide a computer storage medium, including a computer program, which will cause a computer to carry out the information indication method as described in the embodiments of the first aspect in a repeater.

Embodiments of this disclosure provide a computer program, which, when executed in a network device, will cause a computer to carry out the information indication method described in the embodiments of the third aspect in the network device.

Embodiments of this disclosure provide a computer storage medium, including a computer program, which will cause a computer to carry out the information indication method as described in the embodiments of the third aspect in a network device.

The above apparatuses and methods of this disclosure may be implemented by hardware, or by hardware in combination with software. This disclosure relates to such a computer-readable program that when the program is executed by a logic device, the logic device is enabled to carry out the apparatus or components as described above, or to carry out the methods or steps as described above. This disclosure also relates to a storage medium for storing the above program, such as a hard disk, a floppy disk, a CD, a DVD, and a flash memory, etc.

The methods/apparatuses described with reference to the embodiments of this disclosure may be directly embodied as hardware, software modules executed by a processor, or a combination thereof. For example, one or more functional block diagrams and/or one or more combinations of the functional block diagrams shown in the drawings may either correspond to software modules of procedures of a computer program, or correspond to hardware modules. Such software modules may respectively correspond to the steps shown in the drawings. And the hardware module, for example, may be carried out by firming the soft modules by using a field programmable gate array (FPGA).

The soft modules may be located in an RAM, a flash memory, an ROM, an EPROM, and EEPROM, a register, a hard disc, a floppy disc, a CD-ROM, or any memory medium in other forms known in the art. A memory medium may be coupled to a processor, so that the processor may be able to read information from the memory medium, and write information into the memory medium; or the memory medium may be a component of the processor. The processor and the memory medium may be located in an ASIC. The soft modules may be stored in a memory of a mobile termination, and may also be stored in a memory card of a pluggable mobile termination. For example, if equipment (such as a mobile termination) employs an MEGA-SIM card of a relatively large capacity or a flash memory device of a large capacity, the soft modules may be stored in the MEGA-SIM card or the flash memory device of a large capacity.

One or more functional blocks and/or one or more combinations of the functional blocks in the drawings may be realized as a universal processor, a digital signal processor (DSP), an application-specific integrated circuit (ASIC), a field programmable gate array (FPGA) or other programmable logic devices, discrete gate or transistor logic devices, discrete hardware component or any appropriate combinations thereof carrying out the functions described in this application. And the one or more functional block diagrams and/or one or more combinations of the functional block diagrams in the drawings may also be realized as a combination of computing equipment, such as a combination of a DSP and a microprocessor, multiple processors, one or more microprocessors in communication combination with a DSP, or any other such configuration.

This disclosure is described above with reference to particular embodiments. However, it should be understood by those skilled in the art that such a description is illustrative only, and not intended to limit the protection scope of the present disclosure. Various variants and modifications may be made by those skilled in the art according to the spirits and principle of the present disclosure, and such variants and modifications fall within the scope of the present disclosure.

As to implementations containing the above embodiments, following supplements are further disclosed.

1. An information indication method, applicable to a repeater, characterized in that the method comprises:

receiving first control information by a mobile termination of the repeater, the first control information at least including first information for indicating a time domain resource,

a forwarding unit of the repeater being in a first state, or a second state, or a third state within the time domain resource indicated by the first information.

2. The method according supplement 1, wherein the forwarding unit of the repeater being in a first state within a time domain resource indicated by the first information includes that the forwarding unit forwards signals at the time domain resource;

the forwarding unit of the repeater being in a second state within a time domain resource indicated by the first information includes that the forwarding unit is in a standby state within the time domain resource, or that the forwarding unit stops forwarding signals within the time domain resource, or that the forwarding unit does not forward signals within the time domain resource, or that the forwarding unit is capable of forwarding signals within the time domain resource;

the forwarding unit of the repeater being in a third state within a time domain resource indicated by the first information includes that the forwarding unit is in an OFF state within the time domain resource, or that the forwarding unit stops forwarding signals within the time domain resource, or that the forwarding unit does not forward signals within the time domain resource, or that the forwarding unit is capable of forwarding signals within the time domain resources, or that the forwarding unit is incapable of forwarding signals within the time domain resources.

3. The method according to supplement 1 or 2, wherein the first information indicates that the forwarding unit is in the third state within the time domain resource, and the mobile termination does not receive a part or all of downlink signals within the time domain resource, and/or does not transmit a part or all of uplink signals.

4. The method according to any one of supplements 1-3, wherein the first information indicates that the forwarding unit is in the third state within the time domain resource, and within the time domain resource, the mobile termination does not monitor a DCI format used to indicate the forwarding unit to forward signals, or within the time domain resource, the mobile termination does not expect to receive second control information indicating the forwarding unit to forward signals, or the mobile termination does not expect to receive second control information indicating the forwarding unit to forward signals within the time domain resource.

5. The method according to any one of supplements 1-3, wherein the first information indicates that the forwarding unit is in the second state or third state within the time domain resource, and the mobile termination monitors a DCI format used to indicate the forwarding unit to forward signals within the time domain resource, or within the time domain resource, the mobile termination receives second control information indicating the forwarding unit to forward signals within the time domain resource, or, after receiving the first control information, the mobile termination receives second control information indicating the forwarding unit to forward signals within the time domain resource.

6. The method according to any one of supplements 1-5, wherein the first information is carried by one or more first information fields.

7. The method according to any one of supplements 1-5, wherein the first information explicitly indicates that the forwarding unit is in the first state or the second state or the third state within the time domain resource.

8. The method according to supplement 7, wherein the first control information does not include second information used for indicating one or more access link beams.

9. The method according to supplement 8, wherein the second information is carried by one or more second information fields.

10. The method according to any one of supplements 7 to 9, wherein that the first information explicitly indicates that the forwarding unit is in the first state or the second state or the third state within the time domain resource indicates that the first information is only used to indicate that the forwarding unit is in the first state or the second state or the third state within the time domain resource.

11. The method according to supplement 7, wherein the first control information further includes third information for indicating the first state or the second state or the third state.

12. The method according to supplement 10, wherein an operating frequency band of the repeater is at FR1.

13. The method according to any one of supplements 1-5, wherein the first information implicitly indicates that the forwarding unit is in the first state or the second state or the third state within the time domain resource.

14. The method according to supplement 13, wherein the first control information further includes second information for indicating one or more access link beams.

15. The method according to supplement 14, wherein the second information is carried by one or more second information fields.

16. The method according to supplement 13, wherein the first information is further used to indicate a time domain resource/time domain resources to which the one or more access link beams indicated by the second information correspond(s).

17. The method according to supplement 13, wherein an operating frequency band of the repeater is at FR2.

18. The method according to any one of supplements 1-17, wherein whether the first control information includes the second information for indicating access link beams is related to an operating frequency band and/or capability and/or higher layer parameter configuration of the forwarding unit.

19. The method according to any one of supplements 1-18, wherein the first control information includes DCI and/or RRC signaling and/or an MAC CE.

20. The method according to any one of the supplements 1-19, wherein a first spacing between a first time position related to the first control information and a second time position of a time domain resource indicated by the first information is greater than or not less than a first predetermined value or a second predetermined value.

21. The method according to supplement 20, wherein the first predetermined value is greater than the second predetermined value.

22. The method according to supplement 20 or 21, wherein the first predetermined value includes a time needed by the forwarding unit for being switched from a third state to a second state or a first state, or the first predetermined value includes a time needed by the forwarding unit for being switched from a third state to a second state and a time needed by the forwarding unit for being switched from a second state to a first state, or, the first predetermined value includes a time needed by the forwarding unit for being switched from a third state to a second state and a time needed in beam switching.

23. The method according to supplement 20 or 21, wherein the second predetermined value includes a time needed by the forwarding unit for being switched from a second state to a first state, or the second predetermined value includes a time needed in beam switching.

24. The method according to supplement 22, wherein the time needed in being switched from the third state to the first state includes or does not include the time needed in beam switching.

25. The method according to supplement 22 or 23, wherein the time needed in being switched from the second state to the first state includes or does not include the time needed in beam switching.

26. The method according to any one of the supplements 20-25, wherein the first predetermined value and/or the second predetermined value include(s) or do(es) not include a time needed by the mobile termination in receiving the first control information.

27. The method according to any one of the supplements 20-26, wherein the forwarding unit is in the third state when the mobile termination receives the first control information or the forwarding unit is in the third state before the time domain resource indicated by the first information, and is in the first state within the time domain resource indicated by the first information, and the first spacing is greater than or not less than the first predetermined value.

28. The method according to supplement 27, wherein the forwarding unit is in the second state in receiving the first control information or the forwarding unit is in the second state before the time domain resource indicated by the first information, and is in the first state within the indicated time domain resource, and the first spacing is greater than or not less than the second predetermined value.

29. The method according to any one of the supplements 1-19, wherein a second spacing between a third time position related to the first control information and a fourth time position of the time domain resource indicated by the first information is greater than or not less than a third predetermined value or a fourth predetermined value.

30. The method according to supplement 29, wherein the third predetermined value is greater than the fourth predetermined value.

31. The method according to supplement 29 or 30, wherein the first control information includes the second information for indicating one or more access link beams, and the second spacing is greater than or not less than the third predetermined value.

32. The method according to supplement 29 or 30, wherein the first control information does not include the second information for indicating one or more access link beams, and the second spacing is greater than or not less than the fourth predetermined value.

33. The method according to any one of supplements 1-32, wherein the method further includes:

transmitting HARQ-ACK information to which the first control information corresponds by the mobile termination of the repeater, a starting position of the time domain resource indicated by the first information being after or before or identical to an ending position of a time domain resource used for transmitting the HARQ-ACK information.

34. The method according to any one of supplements 1-33, wherein the repeater transmits the HARQ-ACK information to which the first control information corresponds, and a position of the time domain resource indicated by the first information is unrelated to a position of the time domain resource used for transmitting the HARQ-ACK information.

35. An information indication method, applicable to a network device, characterized in that the method includes:

transmitting first control information by the network device to a repeater, the first control information at least including first information for indicating a time domain resource, and/or transmitting or not transmitting second control information, the second control information being used to indicate a forwarding unit to forward signals within a time domain resource.

36. A repeater, including a memory and a processor, the memory storing a computer program, and the processor being configured to execute the computer program to carry out the information indication method as described in any one of supplements 1-34.

37. A network device, including a memory and a processor, the memory storing a computer program, and the processor being configured to execute the information indication method as described in supplement 35.

1. A repeater, comprising:
a mobile termination configured to communicate with a network device via a control link to receive control information; and,
a forwarding entity, configured to perform amplifying-and-forwarding of uplink (UL) and/or downlink (DL) radio frequency (RF) signals between the network device and a terminal equipment via a backhaul link and an access link, a behavior of the forwarding entity being controlled according to the control information received by the mobile termination, wherein, states of the forwarding entity include ON state to transmit signals and OFF state to not transmit signals;
wherein the control information includes a first information used for indicating a time domain resource and a second information used for indicating a beam for the access link by indicating a beam index of the beam, and the forwarding entity is controlled to be in the ON state in the time domain resource indicated by the first information and associated with the beam indicated by the second information, wherein transmitter OFF power is a power in the OFF state according to a frequency range (FR).

2. The repeater according to claim 1, wherein, if the frequency range (FR) is a FR1, transmitter OFF power for downlink and transmitter OFF power for uplink are different.

3. The repeater according to claim 1, wherein, if the forwarding entity operates the frequency range (FR) as a FR1, for downlink, transmitter OFF power is less than −85 dBm/MHz; for uplink, transmitter OFF power is less than −50 dBm/(SCS×(12×N_{RB}+1)/1000) MHz, where SCS is Sub Carrier Spacing in kHz, N_{RB} is the number of resource blocks; and,
if the forwarding entity operates the frequency range (FR) as a FR2, transmitter OFF power is less than −36 dBm/MHz.

4. The repeater according to claim 3, wherein the transmitter OFF power is a mean power measured over a time length during the OFF state, the time length is related to the SCS.

5. The repeater according to claim 3, wherein if the forwarding entity operates the frequency range (FR) as a FR1, for downlink, transmitter OFF power is less than −85 dBm/MHz per antenna connector; for uplink, transmitter OFF power is less than −50dBm/(SCS×(12×N_{RB}+1)/1000) MHz per antenna connector.

6. The repeater according to claim 1, wherein the forwarding entity supports to change from the OFF state to the ON state or to change from the ON state to the OFF state.

7. The repeater according to claim 6, wherein a requirement for a transient period is different according to frequency ranges (FR), the transient period is a time period during which the forwarding entity is changing from the OFF state to the ON state or from the ON state to the OFF state.

8. The repeater according to claim 7, wherein, if the forwarding entity operates the frequency range as a FR1, a transient period is shorter than 10 us, if the forwarding entity operates at FR2, a transient period is shorter than 3 us.

9. The repeater according to claim 1, the control information includes a DCI format with CRC scrambled by an NCR-RNTI which is monitored in USS sets.

10. A network device, comprising:
a transmitter configured to transmit control information to a repeater via a control link, a behavior of a forwarding entity of the repeater being controlled according to the control information, wherein, states of the forwarding entity include ON state to transmit signals and OFF state to not transmit signals;
wherein the control information includes a first information used for indicating a time domain resource and a second information used for indicating a beam for the access link by indicating a beam index of the beam, and the forwarding entity is controlled to be in the ON state in the time domain resource indicated by the first information and associated with the beam indicated by the second information, wherein transmitter OFF power is a power in the OFF state according to a frequency range (FR).

11. A communication system, comprising a repeater and a network;
wherein the repeater is configured to communicate with the network device via a control link to receive control information; and configured to perform amplifying-and-forwarding of uplink (UL) and/or downlink (DL) radio frequency (RF) signals between the network device and a terminal equipment via a backhaul link and an access link, a behavior of a forwarding entity of the repeater being controlled according to the control information received by a mobile termination of the repeater, wherein, states of the forwarding entity include ON state to transmit signals and OFF state to not transmit signals; and
wherein the control information includes a first information used for indicating a time domain resource and a second information used for indicating a beam for the access link by indicating a beam index of the beam, and the forwarding entity is controlled to be in the ON state in the time domain resource indicated by the first information and associated with the beam indicated by the second information, wherein transmitter OFF power is a power in the OFF state according to a frequency range (FR).
